(19) United States
(12) Patent Application Publication
(10) Pub. No.: US 2007/0053749 A1
(43) Pub. Date: Mar. 8, 2007

(54) Pipe assembly and a method for installation in a borehole

(75) Inventors: Darrel Jarvis, Clyde (CA); Alan O'Brien, Westlock (CA)

Correspondence Address: RODMAN RODMAN, 7 SOUTH BROADWAY, WHITE PLAINS, NY, 10601, US

(73) Assignee: DRAG'N SKIN INTERNATIONAL INC., Clyde (CA)

(21) Appl. No.: 10/569,536

(22) PCT Filed: Sep. 30, 2003
(86) PCT No.: PCT/CA03/01436

§ 371 Date: Feb. 23, 2006

(51) Int. Cl. F16L 55/16

(52) U.S. Cl. 405/154.1; 138/98

(57) ABSTRACT

A method for installing a pipe in a borehole and a pipe assembly for installation are provided which reduce the likelihood of any damage to the pipe during installation. The method for installing the pipe in the borehole includes: advancing a running device through the borehole from a proximal end toward a distal end: connecting a pipe assembly with the running device from the distal end, the pipe assembly including, the pipe and a flexible sleeve surrounding the pipe: retracting the running device through the borehole toward the proximal end so that the pipe assembly moves toward the proximal end: and disconnecting the pipe assembly from the running device. The pipe assembly includes a pipe having a protective coating and a flexible sleeve surrounding the pipe comprised of a continuous length of a flexible sleeve material. The flexible sleeve may he comprised of a length of a hose.

### FIELD OF INVENTION

The present invention relates to a method for installing a pipe, and more particularly a pipe assembly comprised of the pipe, in a borehole. Further, the present invention relates to a pipe assembly for installation in a borehole comprised of a pipe and a flexible sleeve surrounding the pipe.

### BACKGROUND OF INVENTION

In the underground installation of pipes, the longevity or durability of the pipe following its installation is dependent upon, at least in part, the structural integrity or soundness of the pipe at the time of the installation. Further, to enhance or increase the longevity of the pipe, the pipe may be provided with a protective coating depending upon the particular intended use of the pipe and the particular material comprising the pipe.

For instance, the pipe may be comprised of a material subject to corrosion or other deterioration within the borehole, such as metal or fiberglass. Accordingly, the underground pipe may include a corrosion-resistant, microbial-resistant or other protective coating. Such coatings are typically comprised of one or more layers of a protective material, substance or film applied to or spread over the surface of the pipe such that the outer surface of the pipe is encased thereby. The protective coating tends to protect the pipe from damaging or deleterious substances, fluids, microbes, etc. which may be found within the borehole and which tend to corrode or otherwise deteriorate the pipe following its installation.

For example, U.S. Pat. No. 6,183,825 issued Feb. 6, 2001 t o Crook. U.S. Pat. No. 6,224,957 issued May 1, 2001 to Crook et. al. and U.S. Pat. No. 6,448,998 issued Dec. 3, 2002 to Crook each describe a variety of anti-corrosion materials which encase the pipe or are applied as a component of a polyolefin film in order to protect the buried pipe from corrosion, including corrosion inhibitors and various anti-microbials, bactericides and biocides for preventing bacterial induced or enhanced corrosion or degradation of the pipe.

Accordingly, where the pipe includes a protective coating, the longevity or durability of the pipe following its installation will be dependent upon, at least in part, the structural integrity or soundness of the protective coating at the time of the installation. As a result, the pipe is typically inspected prior to its installation in the borehole to ascertain and ensure the integrity or soundness of both the pipe and its protective coating.

In addition, the integrity of the pipe and its protective coating must be substantially maintained or not adversely affected during its installation within or through the borehole as any damage to the pipe or crackling, breaking, tearing or abrasion of the protective coating may negatively impact the structural integrity of the pipe. More instance, damage to the protective coating permits access to the underlying pipe such that deleterious or injurious substances or materials may corrode or deteriorate the pipe and ultimately weaken its structure.

Damage to the pipe and its protective coating may occur during any type or nature of underground installation. However, the likelihood of such damage occurring is increased when the pipe is to be installed or placed within soil or underground formations or conditions which are particularly rocky or which include a significant proportion of rock, gravel or debris. In this instance, the rock gravel or debris may impact, collide with or abrade the pipe and its protective coating as the pipe passes through the borehole, potentially causing damage to occur to the pipe and the protective coating.

When such conditions are encountered, the pipe may need to be removed from the borehole to be re-inspected to ensure that the pipe and its protective coating have not been damaged. In the event that removal and further inspection of the pipe are warranted, there will be a corresponding undesirable increase in the time and costs associated with the pipe installation.

Various approaches have been taken to address the potential damage that can be incurred by the pipe and the protective coating during the installation process. However, none of these approaches have been found to be fully satisfactory.

For instance, U.S. Pat. No. 3,546,890 issued Dec. 15, 1970 to Ede and U.S. Pat. No. 3,641,780 issued Feb. 15, 1972 to Ede describe the trenchless laying of pipe underground. Ede describes the use of a mole plough to form an underground tunnel for receipt of the pipe therein. However, in forcing the pipe through the tunnel into its final position, Ede recognizes that any corrosion-resistant surface coating of paint or plastic on the pipe is liable to be scraped off.

As a result, Ede proposes the use of a corrosion-resistant sleeve which is fed underground through the advancing mole plough and is progressively laid in position behind the mole in the newly-formed tunnel to line the tunnel as the mole plough is advanced through the soil. The end of the sleeve is anchored at or near the start of the tunnel. A length of pipe is then inserted through the end of the sleeve anchored at the start of the tunnel and thrust forwards lengthwise along the tunnel and within the sleeve laid behind the advancing mole plough. In other words, the tunnel is ploughed and the sleeve is laid within the tunnel concurrently. As the sleeve is laid in position within the tunnel, the pipe is inserted in the sleeve and moved into its desired position.

The sleeve is comprised of a plain or corrugated watertight flexible tube made of a suitable plastics material such as polythene. However, as the sleeve is laid directly into the tunnel behind the mole plough, the sleeve is not inserted or forced through the tunnel in any manner. Accordingly, as the corrosion-resistant sleeve described in Ede is not forced through the tunnel, it is unlikely to be subjected to collision or impact damage or abrasion and thus need not be comprised of an impact, collision or abrasion resistant material. As described in Ede, the sleeve is provided solely as a corrosion-resistant sleeve and to perform a corrosion-resistance function for the pipe which is subsequently inserted in the sleeve following the installation of the sleeve in the tunnel.

Thus, Ede addresses the likelihood of damage to the corrosion-resistant coating by dispensing with the coating altogether and providing specialized equipment for laying a specialized sleeve designed and selected solely to perform a corrosion-resistance function. Accordingly, Ede may not be useful or applicable in all circumstances. For instance, Ede does not address the circumstance where the pipe with its corrosion-resistant sleeve may need to be moved within the tunnel following its initial installation. In this case, the corrosion-resistant sleeve may be punctured or damaged by any movement in the timely as the sleeve of Ede does not contemplate this use. Further, Ede does not specifically address or contemplate the situation in which a pipe having a protective coating is required or desired to be used.

U.S. Pat. No. 5,527,070 issued Jun. 18, 1996 to Blackwell describes a means to provide protection to a pipe system against pipe movement and joint connection disruption during the swelling and shrinking process of the surrounding expansive soil. Specifically, Blackwell describes a plastic-like wrapping of the main pipe section and a plastic-like covered cushion layer of the joint connections.

The plastic-like wrapping is comprised of an elongate section of “plastic-like” material having opposed longitudinal edges, which length of material is wrapped longitudinally around the pipe section such that the opposed longitudinal edges are brought together. The longitudinal edges are secured in place by longitudinal tape. The plastic-like covered cushion layer of the joint connections is similarly comprised of an elongate section of “plastic-like” material having opposed ends and opposed longitudinal edges. The length of material is wrapped longitudinally around the joint connections such that the opposed longitudinal edges are brought together and such that the opposed ends are positioned on either side of the joint connection. The longitudinal edges are secured in place by longitudinal tape, while the opposed ends are each secured in place by circumferential tape.

Further, the invention of Blackwell is described for use when installing the pipe within a trench. No suggestion is provided regarding its use in a borehole or in a trenchless installation. This is likely due to the fact that the plastic-like material is held in place solely by tape and therefore the material may be dislodged or removed upon forcing of the pipe through a borehole.

As a result, there is a need in the industry for an improved method for installing a pipe in a borehole and an improved pipe assembly comprised of a pipe for installation in a borehole, wherein the method and pipe assembly reduce the likelihood of any impact or collision damage or any abrasion to the pipe during the installation process. Further, there is a particular need for the improved method and pipe assembly where the pipe has a protective coating such that the method and pipe assembly reduce the likelihood of any damage to or interference with the structural integrity of the protective coating during the installation process.

### SUMMARY OF INVENTION

The present invention relates to a method for installing a pipe in a borehole, wherein the method reduces the likelihood of impact, collision or abrasive damage occurring to the pipe during its installation. The pipe preferably includes a protective coating, and thus, the method also preferably reduces the likelihood of any damage to the protective coating as the pipe is inserted or advanced through the borehole. In the preferred embodiment, the method is comprised of installing the pipe in the borehole as a component of a pipe assembly which is comprised of the pipe and a flexible sleeve surrounding pipe.

Further, the present invention relates to a pipe assembly for installation in a borehole, wherein the pipe assembly is comprised of a pipe and a flexible sleeve surrounding the pipe. Preferably, the pipe is comprised of a protective coating and the flexible sleeve is comprised of a continuous length of a flexible sleeve material. The pipe assembly is provided to reduce the likelihood of any damage, particularly impact, collision or abrasive damage, to the pipe or any protective coating of the pipe during its installation in the borehole.

Thus, the method and the pipe assembly described herein preferably provide protection to the pipe and any protective coating thereof during installation within the borehole. It has been found that the within invention is particularly useful in circumstances in which the borehole extends through or within soil or underground formations or conditions which are particularly rocky or which include a significant proportion of rock, gravel or debris. In this instance, the rock, gravel or debris may tend to impact, collide with or abrade the pipe and its protective coating as it passes through the borehole.

In a first aspect of the invention, the invention is comprised of a method for installing a pipe in a borehole, wherein the borehole is comprised of a proximal borehole end and a distal borehole end, the method comprising the following steps:
(a) advancing a running device through the borehole from the proximal borehole end toward the distal borehole end;
(b) connecting a pipe assembly with the running device from the distal borehole end, wherein the pipe assembly is comprised of:
   (i) the pipe; and
   (ii) a flexible sleeve surrounding the pipe;
(c) retracting the running device through the borehole toward the proximal borehole end so that the pipe assembly moves through the borehole toward the proximal borehole end; and
(d) disconnecting the pipe assembly from the running device.

In a second aspect of the invention, the invention is comprised of a pipe assembly for installation in a borehole, the pipe assembly comprising:
(a) a pipe, wherein the pipe is comprised of a protective coating; and
(b) a flexible sleeve surrounding the pipe, wherein the flexible sleeve is comprised of a continuous length of a flexible sleeve material.

In the first and second aspects, the pipe may be comprised of any elongate member or structure desired or required to be installed in an underground borehole. Preferably, the elongate member or structure is comprised of a hollow cylindrical or tubular member or structure such that a bore is defined therethrough to provide a passage for any desired fluids or underground structures such as electrical wires or cables.

Further, the pipe may be comprised of any material compatible with, and suitable for, an underground installation and having sufficient rigidity to permit its passage through the borehole. More particularly, the pipe may be comprised of any material compatible with the intended use of the pipe underground, the anticipated soil conditions in which the pipe is to be installed and any other surrounding or environmental conditions to which the pipe is likely to be exposed. Thus, the pipe may be comprised of such materials as plastic, concrete, fiberglass, metal or metal reinforced concrete. In the preferred embodiment, the pipe is comprised of a metal, preferably steel.

Further, the pipe has a pipe length. Specifically, the pipe has a first pipe end and an opposed second pipe end, wherein the pipe length is defined therebetween. The pipe may be comprised of a single unitary tubular or hollow cylindrical member or a single pipe section extending between the first and second pipe ends to provide the desired pipe length. Alternately, the pipe may be comprised of two or more tubular or hollow cylindrical members or pipe sections connected, fastened or mounted together either permanently or releasably, to provide the desired pipe length. In this case, the pipe sections may be connected, fastened or otherwise mounted together in any manner and by any rigid or releasable fastening or mounting mechanism or process. For instance, the adjacent ends of the pipe sections may be rigidly mounted together by welding. Alternately, the adjacent ends of the pipe sections may be releasably or removably mounted together by a threaded connection therebetween, such as by the use of compatible threaded box and pin connectors.

The pipe may have any desired or required pipe length compatible with the intended application or use of the pipe and compatible with the borehole in which the pipe is to be installed. In addition, the pipe has a diameter defined by an outer surface of the pipe. The pipe may have any desired or required pipe diameter compatible with the intended application or use of the pipe and compatible with the borehole in which the pipe is to be installed.

The method and the pipe assembly relate to an installation within a borehole which is comprised of a proximal borehole end and a distal borehole end. More particularly, both the proximal and distal borehole ends are located or positioned at the ground surface or are positioned within a bell hole or surface excavation such that the proximal and distal borehole ends are readily accessible from the ground surface. Further, the borehole has a borehole length which extends between the proximal and distal borehole ends substantially underground or beneath the ground surface.

The borehole may have any desired or required borehole length. However, the pipe length and the borehole length are selected to be compatible with each other such that the length of pipe may be installed within the length of the borehole at a particular installation site. In addition, the borehole may have any desired or required borehole diameter. However, as with the borehole and pipe lengths, the pipe diameter and the borehole diameter are also selected to be compatible with each other such that the pipe may be installed within the borehole at a particular installation site.

As well, the borehole, and thus the pipe to be installed therein, may be positioned or located at any desired depth beneath the surface. However, preferably, the borehole is relatively superficially positioned beneath the ground surface.

As indicated, the method is provided for installing the pipe in the borehole. More particularly, the method installs the pipe in the borehole as a component of a pipe assembly. In this instance, the pipe assembly is comprised of the pipe and a flexible sleeve surrounding the pipe. However, in the preferred embodiment of the method, the method is utilized for installing the preferred pipe assembly described herein, and particularly, the preferred embodiment of the pipe assembly. The pipe to be installed in the borehole may be referred to in the industry as the “drag section.” Accordingly, the pipe assembly of the within invention may also be referred to as the “drag section.”

Accordingly, the pipe is preferably comprised of a protective coating. The protective coating may be comprised of any substance, material or film applied to, spread upon or otherwise covering, overlying or comprising at least a portion of the pipe which is provided to reduce or inhibit any corrosion or other degradation of the pipe following its installation in the borehole. The protective coating extends along at least a portion of the pipe length about at least a portion of the circumference or outer surface of the pipe. In the preferred embodiment, the protective coating extends along substantially the entire pipe length and about substantially the entire circumference or outer surface of the pipe.

Further, the pipe assembly is comprised of a flexible sleeve surrounding the pipe. The flexible sleeve is provided to reduce the likelihood of any damage to or abrasion or bruising of the pipe and the protective coating during the installation in the borehole. The flexible sleeve surrounds or covers the complete or entire circumference of the pipe. In addition, the flexible sleeve extends along at least a portion of the pipe length and preferably extends along substantially the entire pipe length intended to be installed within the borehole or to pass through the borehole during the installation. In other words, the sleeve preferably surrounds any portion of the pipe and its protective coating which are likely to contact the ground or the borehole during installation.

The flexible sleeve may be comprised of any flexible material capable of, and suitable for, performing the intended function of the sleeve as described herein. The flexible sleeve is preferably comprised of a flexible sleeve material which does not substantially or significantly restrict or inhibit any bending deflection or movement of the pipe positioned therein during the installation of the pipe in the borehole. Further, the flexible nature of the sleeve preferably permits any necessary bending, deflection or movement of the flexible sleeve prior to or during the installation without damaging, cracking or breaking the flexible sleeve, even in the event of adverse environmental conditions such as colder temperatures. Finally, the flexible nature of the flexible sleeve material preferably facilitates the placement or insertion of the pipe within the flexible sleeve prior to installation in the borehole, as described further below.

The flexible sleeve material defines a first sleeve end, an opposed second sleeve end and a length of the flexible sleeve extending between the first and second sleeve ends. The length of the flexible sleeve may be comprised of a two or more sections or portions of flexible sleeve material having their adjacent ends affixed, joined or otherwise fastened together to form the flexible sleeve. In this case, the portions or sections of flexible sleeve material are preferably fixedly or non-releasably fastened together at their adjacent ends by circumferential seams.

However, whenever two or mores sections or portions are required to be fastened together, the possibility exists that the sections or portions may become disconnected, unfastened or torn at the connection point during installation. As a result, the length of the flexible sleeve material is preferably comprised of a single or unitary section or portion of flexible material extending between the first and second sleeve ends. In other words, in the preferred embodiment, the flexible sleeve is comprised of a continuous length of the flexible sleeve material.

The flexible sleeve, and thus the flexible sleeve material, may have any desired or required sleeve length compatible with the length of pipe intended to be installed in the borehole. In other words, the length of the flexible sleeve is preferably selected to extend for at least the length of the pipe to be inserted in or through the borehole such that any portion of the pipe to be exposed to the borehole is protected by the flexible sleeve. Thus, in the preferred embodiment, the flexible sleeve surrounds the pipe along substantially the entire pipe length.

In addition, the flexible sleeve preferably has a shape, size and configuration compatible with the pipe to be accepted or received therein. In other words, the flexible sleeve is adapted for receipt of the pipe therein. More particularly, the flexible sleeve is adapted such that the pipe may be readily or relatively easily inserted therein. Thus, given the cylindrical nature of the pipe, the flexible sleeve also preferably has a tubular or cylindrical shape and a sleeve diameter defined by an outer surface of the flexible sleeve.

The flexible sleeve diameter is greater than the pipe diameter to permit the pipe to be received therein. In addition, the flexible sleeve diameter preferably provides for or allows the pipe to be relatively snugly or closely received within the flexible sleeve while not substantially interfering with or impeding the insertion of the pipe within the flexible sleeve. In other words, in the preferred embodiment, the flexible sleeve diameter is no greater than that required or necessary to permit the pipe to be readily or relatively easily inserted in the flexible sleeve.

The flexible sleeve may be comprised of any flexible sleeve material as discussed above. However, in the preferred embodiment, the flexible sleeve material is seamless. Thus, the flexible sleeve is preferably comprised of a continuous seamless length of the flexible sleeve material such that the flexible sleeve material extends between the first and second sleeve ends without any seams or joins in the flexible sleeve material. Thus, as discussed above, the continuous length of flexible sleeve material preferably does not include any circumferential seams or joins. However, in addition, the continuous length of flexible sleeve material does not include any longitudinally oriented seams or joins.

Accordingly, the flexible sleeve may be comprised of a length of a hose. The length of the hose is preferably continuous and seamless. Although any type of hose having the desired characteristics may be used, the hose is preferably an industrial hose such as a fire hose. Thus, the flexible sleeve may be comprised of a length of an industrial hose, including a length of a fire hose.

Although any flexible sleeve material may be used to form the flexible sleeve or the hose (for example, Kevlar™), the flexible sleeve material is preferably comprised of a woven material. The woven material may be any woven material or fabric compatible with, and suitable for, the intended use of the flexible sleeve as described herein. Thus, the woven material must be flexible, as described above, while also having sufficient strength and durability to permit its insertion through, and installation in, the borehole without incurring any substantial or significant damage adversely affecting or impairing its structural integrity. In other words, the woven material must be of a quality or character capable of providing protection to the pipe within the flexible sleeve while the flexible sleeve advances or moves though the borehole.

For instance, the woven material may be comprised of a woven nylon material or a woven polyester material. However, preferably, the flexible sleeve material is comprised of a woven polyester material. Accordingly, where the flexible sleeve is comprised of a length of a hose, the hose is preferably comprised of a woven polyester material which may also be referred to as a woven polyester hose material.

The woven material, including the woven polyester material, may have any type of weave depending upon the desired performance qualities or characteristics of the resulting woven fabric including the flexibility, abrasion resistance or smoothness of the bore. For instance, the woven material, including the woven polyester material and the woven polyester hose material, may have a plain or straight weave, or a twill or bias weave. Typically, the twill weave tends to be relatively more flexible, more abrasion resistant and more rugged than a comparable plain weave.

Accordingly, in the preferred embodiment, the flexible sleeve material is comprised of a twill weave woven polyester material. Thus, where the flexible sleeve is comprised of a length of a hose, the hose is preferably comprised of the twill weave woven polyester material which may also be referred to as a twill weave woven polyester hose material. In addition, the flexible sleeve material may be further comprised of a thermoplastic polyurethane material. Similarly, where the flexible sleeve is comprised of a length of a hose, the hose is also preferably comprised of the thermoplastic polyurethane material.

Woven material is typically provided in layers or jackets of woven material. Thus, the flexible sleeve material may be comprised of one or more layers or jackets of woven material. Similarly, the hose may be comprised of one or more layers or jackets of woven material. Although the flexible sleeve material may be comprised of a single jacket of woven material, preferably, the flexible sleeve material is comprised of at least two layers or jackets of woven material which are inserted or positioned within each other to form the flexible sleeve material. In the preferred embodiment, the flexible sleeve material is comprised of two layers or jackets of the woven material. More particularly, an inner layer or jacket of woven material is positioned or placed within an outer layer or jacket of the woven material to provide or form the flexible sleeve material.

Further, where desirable, the flexible sleeve may be comprised of either or both of a sleeve coating or a sleeve lining. Each of the sleeve coating and the sleeve lining may be selected to impart or provide desirable properties to the flexible sleeve. For instance, the sleeve coating may enhance or provide desirable qualities to the flexible sleeve such as improved durability or abrasion resistance of the flexible sleeve or increased rigidity of the flexible sleeve in order to provide the preferred degree of flexibility. The sleeve lining may also enhance or provide desirable qualities to the flexible sleeve such as those listed above for the sleeve coating or to decrease the friction between the adjacent surfaces of the inner surface of the flexible sleeve and the outer surface of the pipe in order to facilitate the insertion of the pipe within or through the flexible sleeve.

In the preferred embodiment, the flexible sleeve is comprised of the sleeve lining, wherein the sleeve lining is comprised of a thermoplastic polyurethane material. The thermoplastic polylurethane material is believed to facilitate the passage of the pipe through the flexible sleeve. The thermoplastic polyurethane material may comprise a separate or distinct layer which lines or lies within at least a portion of the innermost surface of the flexible sleeve material comprising the inner surface of the flexible sleeve. However, preferably, at least a portion of the innermost surface of the flexible sleeve material is comprised of the thermoplastic polyurethane material such that the thermoplastic polyurethane material forms an integral part thereof or is securely fastened or affixed therewith. For instance, the thermoplastic polyurethane material may be spread or extruded upon or otherwise conjoined or intimately associated with the innermost surface of the flexible sleeve material. In the preferred embodiment, the innermost surface of the inner layer or jacket of the woven material comprising the flexible sleeve material is comprised of the thermoplastic polyurethane material.

Further, the flexible sleeve may be comprised of the sleeve coating. In this case, the sleeve coating is preferably comprised of a sleeve coating material which may be any substance or material capable of enhancing the abrasion resistance of the flexible sleeve. The sleeve coating material may also increase the rigidity of the flexible sleeve sufficiently to facilitate the passage of the pipe within and through the flexible sleeve while not substantially affecting the desired flexible nature of the flexible sleeve material as discussed above. The sleeve coating material may comprise a separate or distinct layer which coats or covers at least a portion of the outermost surface of the flexible sleeve material comprising the outer surface of the flexible sleeve. Alternately, the outermost surface of the flexible sleeve material may be comprised of the sleeve coating material such that the sleeve coating material forms an integral part thereof or is securely fastened or affixed therewith. For instance, the outermost surface of the flexible sleeve material may be impregnated or saturated with the sleeve coating material.

In the preferred embodiment, the outermost surface of the outer layer or jacket of the woven material comprising the flexible sleeve material is comprised of the sleeve coating material. More particularly, the outermost surface of the outer layer or jacket of the woven material comprising the flexible sleeve material is impregnated or saturated with the sleeve coating material.

The pipe assembly is also preferably further comprised of a coupler for holding the flexible sleeve on the pipe. More particularly, the coupler is required to hold the flexible sleeve on the pipe as the pipe is installed in the borehole such that the relative position of the flexible sleeve on the pipe is maintained as the pipe is inserted within and passes through the borehole. The coupler may be comprised of any device, mechanism or apparatus capable of and suitable for coupling, linking or joining at least a portion of the flexible sleeve to the pipe.

The coupler may couple, link or join the flexible sleeve with the pipe along substantially the entire length of the flexible sleeve or along any part or portion of the flexible sleeve between the opposed first and second sleeve ends. However, preferably, the coupler couples, links or joins the flexible sleeve with the pipe at, adjacent or in proximity to at least one, and more preferably only one, of the ends of the flexible sleeve. In other words, in the preferred embodiment, the coupler is positioned at, adjacent or in proximity to one of the first or second sleeve ends. Specifically, in order to hold the flexible sleeve in position as it passes through the borehole, the coupler is positioned at, adjacent or in proximity to the sleeve end which is to be first inserted within the borehole, as described further below in relation to the method of the within invention.

Further, in the preferred embodiment, the coupler is preferably located at an end of the pipe. When the flexible sleeve is positioned about the pipe, the opposed first and second sleeve ends are located adjacent the opposed first and second pipe ends. In this case, the coupler is positioned at, adjacent or in proximity to one of the first or second pipe ends, wherein the first and second pipe ends are positioned within or located adjacent to the first and second sleeve ends respectively. As indicated above, in order to hold the flexible sleeve in position as it passes through the borehole, the coupler is positioned at, adjacent or in proximity to the pipe end, and thus the sleeve end, which is to be first inserted within the borehole.

Although the coupler may be comprised of any device, mechanism or apparatus capable of and suitable for coupling, linking or joining the flexible sleeve to the pipe as described above, the coupler is preferably adapted or configured such that the flexible sleeve may be relatively easily or readily coupled with and uncoupled from the pipe. Further, the coupler is preferably adapted or configured such that it may advance through or retract from the borehole relatively unimpeded. In other words, the coupler is configured to avoid or minimize any impediments or obstructions to its movement in the borehole. In the preferred embodiment, the coupler is comprised of an inner member connected with the pipe and an outer member for connecting with the inner member such that the flexible sleeve is disposed between the inner member and the outer member.

The inner member has an inner member length and may be comprised of two or more members, components or sections connected, fastened or mounted together, either permanently or releasably, to provide the desired inner member length. However, preferably, the inner member is comprised of a single unitary member, component or section extending for the desired inner member length. Further, the inner member may have any shape or configuration compatible with the pipe such that the inner member may be connected to an end of the pipe. However, in the preferred embodiment, the inner member is comprised of an elongate tubular or cylindrical member.

The inner member may be comprised of any material compatible with, and suitable for, connection with the pipe. Further, the inner member is comprised of a material compatible with the method of installation of the pipe in the borehole described herein such as a metal or fiberglass. In the preferred embodiment, the inner member of the coupler is comprised of a metal, preferably steel.

Further, the inner member may have any outer diameter compatible for connection with the pipe. However, preferably, the inner member has an outer diameter substantially similar to the outer diameter of the pipe. Accordingly, the outer surface of the inner member and the outer surface of the pipe are substantially continuous when the inner member is connected with the pipe.

In addition, the inner member may have any desired length. However, preferably a length is selected such that the flexible sleeve may extend from the end of the pipe to surround the inner member of the coupler for at least a portion of the length of the inner member, and more preferably for substantially the entire length of the inner member of the coupler. In other words, in the preferred embodiment, the flexible sleeve extends from the end of the pipe for a distance such that the flexible sleeve surrounds substantially the entire length of the inner member of the coupler.

Further, the inner member may be connectable with the pipe in any manner and by any fastening or connecting mechanism, structure or means for connecting the adjacent ends of the inner member and the pipe. For instance, the inner member may be either permanently or releasably connected, fastened or mounted with the pipe. For instance, the adjacent ends of the pipe and the inner member may be releasably or removably connected together by a threaded connection therebetween, such as by the use of compatible threaded box and pin connectors. However, preferably, the pipe and the inner member are more rigidly connected, fastened or otherwise mounted together. In the preferred embodiment, the adjacent ends of the pipe and the inner member are connected together by welding, and specifically by providing a butt weld therebetween.

The outer member may have any shape or configuration compatible with the inner member such that the outer member may be connected with the inner member and such that the flexible sleeve may be disposed between the inner member and the outer member. In other words, the outer member is adapted to receive the inner member and the flexible sleeve therein such that the outer member is connectable with the inner member to hold the flexible sleeve therebetween and thereby hold the flexible sleeve in the desired position on the end of the pipe.

The outer member has an outer member length and is comprised of an inner surface for engaging the flexible sleeve. The outer member may be comprised of a single unitary member, component or element extending for the desired outer member length and providing the inner surface. In this case, the outer member may be comprised of an elongate tubular or cylindrical outer member adapted to receive the inner member and the flexible sleeve therein.

However, in order that the outer member may be readily or relatively easily connected with and disconnected from the inner member, the outer member is preferably comprised of two or more members, components or sections which act together to hold the flexible sleeve in position. In this case, when the outer member is connected with the inner member, the components or sections of the outer member together provide or form the elongate tubular or cylindrical outer member. More preferably, the outer member is comprised of two clamping members or shell components which each define a portion of the complete outer member and are positioned along opposed sides of the inner member such that the inner surface of each of the clamping members or shell components engages a portion of the flexible sleeve. In the preferred embodiment, each of the clamping members or shell components are substantially similar.

The outer member may be comprised of any material compatible with, and suitable for, connection with the inner member. Further, the outer member is comprised of a material compatible with the method of installation of the pipe in the borehole described herein, such as a metal or fiberglass. In the preferred embodiment, the outer member of the coupler is also comprised of a metal, preferably steel.

Further, as stated, the outer member is connectable with the inner member such that the inner surface of the outer member engages the flexible sleeve. The inner surface of the outer member may engage the flexible sleeve about any portion of the outer surface or the circumference of the inner member sufficient to hold the flexible sleeve between the inner and outer members during installation. Preferably, the inner surface of the outer member engages the flexible sleeve about substantially the entire outer surface or circumference of the inner member. However, the adjacent side edges of the clamping members may be a spaced distance apart where required to provide an amount of space for receiving any excess flexible sleeve material. As a result, in the preferred embodiment, upon cross-section of the outer member, the inner surface of each of the clamping members or shell components comprising the outer member engages the flexible sleeve about approximately half of the outer surface or circumference of the inner member.

In addition, the outer member may have any desired length. However, preferably a length is selected such that the flexible sleeve may be securely held in position between the inner and outer members of the coupler. Preferably, the outer member length is about equal to or less than the inner member length.

The outer member is comprised of the inner surface for engaging the flexible sleeve. Further, the inner surface is preferably comprised of a gripping surface for resisting movement of the flexible sleeve relative to the inner surface. The gripping surface is provided for enhancing or facilitating the engagement of the inner surface with the flexible sleeve. Further, the gripping surface may be comprised of any gripping structure or mechanism, or may be comprised of any gripping substance or material, capable of enhancing or facilitating the engagement such that the flexible sleeve is securely held or firmly grasped by the inner surface when the outer member is connected with the inner member. For instance, the gripping structure or mechanism may be comprised of a plurality of gripping teeth, while the gripping substance or material may be comprised of any substance enhancing or increasing the friction between the adjacent surfaces or enhancing or aiding the distribution of the force applied by the outer member against the flexible sleeve to resist its movement.

In the preferred embodiment, the inner surface of the outer member is substantially smooth and configured to be compatible with the outer surface of the inner member. However, the inner surface of the outer member is comprised of the gripping surface, and particularly a gripping substance, for resisting movement of the flexible sleeve relative to the inner member. In the preferred embodiment, the gripping surface is comprised of rubber if desired, the outer surface of the inner member may also include a gripping surface or gripping substance. For instance, the outer surface of the inner member may be comprised of a friction enhancing or anti-skid material such a rubber or sandpaper-like material.

The outer member may be connected with the inner member in any manner and by any fastening, mounting or connecting means, mechanism, device or structure capable of connecting the inner and outer members together while the flexible sleeve is disposed -therebetween. Further, the outer member may be either permanently or releasably connected, fastened or mounted with the inner member. However, preferably, the outer and inner members are releasably or removably connected together such that the outer member may be readily or relatively easily connected with and disconnected from the inner member.

In the preferred embodiment, the coupler is further comprised of a plurality of fasteners for connecting the outer member with the inner member. In this case, each of the fasteners extends between the inner and outer members through the flexible sleeve disposed therebetween. Although any type of fasteners may be used, the plurality of fasteners is preferably comprised of a plurality of bolts or self-tapping screws. In addition, any number of fasteners may be used which is capable of securely connecting the inner and outer members and firmly holding the flexible sleeve in between the inner and outer members.

As well, the plurality of fasteners may be positioned longitudinally or axially along the length of the outer member and circumferentially about the outer member in any pattern capable of securely or firmly connecting the inner and outer members and holding the flexible sleeve disposed between the inner and outer members. However, it has been found that in order to inhibit or minimize any tearing or damage to the flexible sleeve, the plurality of fasteners is preferably arranged in a staggered configuration such that none of the fasteners are longitudinally aligned.

With respect to the method for installing the pipe in the borehole, the method is comprised of the step of advancing a running device through the borehole from the proximal borehole end toward the distal borehole end. The borehole may be drilled or formed prior to the advancing step or it may be drilled or formed concurrently with the advancing step. In other words, where the borehole has previously been drilled, a running device is advanced through the borehole from the proximal end to the distal end. In this case, the running device may be comprised of any tool or device capable of being advanced through the borehole and later being retracted from the borehole as described herein.

However, preferably, the borehole is formed or drilled concurrently with the advancing of the running device through the borehole from the proximal borehole end to the distal borehole end. In other words, the running device is advanced through the borehole as the borehole is drilled. Accordingly, the running device is preferably comprised of an underground drilling, boring, reaming or augering device or apparatus capable of forming or providing the borehole from the proximal borehole end to the distal borehole end and later being retracted from the borehole from the distal borehole end to the proximal borehole end. In the preferred embodiment, the running device is comprised of a drilling assembly for drilling the borehole.

Further, the method is comprised of connecting the pipe assembly with the running device from the distal borehole end. The pipe assembly is comprised of the pipe and the flexible sleeve surrounding the pipe, as described above. More particularly, the pipe assembly is preferably comprised of the preferred embodiment of the pipe assembly described herein. The pipe assembly may be connected with the running device in any manner and by any mechanism, apparatus or device capable of providing a secure connection therebetween such that the running device is capable of subsequently retracting through the borehole with the pipe assembly connected thereto. Further, the connecting step may be comprised of permanently or fixedly connecting the pipe assembly with the running device. However, preferably, the connecting step is comprised of removably or releasably connecting the pipe assembly with the running device.

The running device may be connected with any portion or component of the pipe assembly. For instance, the running device may be directly connected with the pipe by any connecting or fastening mechanism or structure. However, preferably the method is further comprised of the step of connecting a pull head with the pipe assembly in order to facilitate the step of connecting the pipe assembly with the running device. Thus, the running device is releasably connected with the pull head. The pull head may be connected with any of the components of the pipe assembly, either permanently or releasably. In the preferred embodiment, the pipe assembly is comprised of the coupler described above and the pull head is connected with the coupler.

Any type or configuration of pull head may be used which is compatible for connection with the pipe assembly and the running device. Further, the pull head may be comprised of any material suitable for connection with the pipe assembly and the running device, such as a metal or fiberglass. In the preferred embodiment, the pull head is comprised of a metal, preferably steel.

Further, the method may be further comprised of the step of assembling the pipe assembly. Specifically, the pipe assembly may require assembly prior to connecting the pipe assembly with the running device. The assembling step may be performed in any manner and by any process capable of providing the flexible sleeve with the pipe positioned therein such that the flexible sleeve surrounds the pipe as described above. In the preferred embodiment, the step of assembling the pipe assembly is comprised of inserting the pipe within a continuous length of the flexible sleeve.

In addition, the method may be further comprised of the step of coupling the pipe with the flexible sleeve in order to hold the flexible sleeve on the pipe during the subsequent step of retracting the running device through the borehole. The coupling step may be performed in any manner and by any type of coupler or coupling mechanism, device or structure as described above. In the preferred embodiment, the coupling step is performed utilizing the preferred coupler as described herein. Thus, the coupling step is comprised of connecting the inner member of the coupler with the end of the pipe and connecting the outer member of the coupler with the inner member such that the flexible sleeve is disposed between the inner and outer members in order to hold the flexible sleeve on the pipe.

Where the coupler is used to perform the coupling step, the method is preferably comprised of the step of connecting the pull head with the coupler in order to facilitate the connecting step. More particularly, the pull head is preferably connected with the inner member of the coupler. The pull head may be connected in any manner, either rigidly or releasably, with the inner member such as by a threaded connection, including compatible threaded box and pin connectors. However, preferably, the pull head is rigidly connected or affixed with the inner member. In the preferred embodiment, wherein the pull head is comprised of a metal, preferably steel, the pull head is welded with the end of the inner member opposite the pipe. In other words, the inner member is welded at one end to the pipe and at the other end to the pull head. The pull head is then connected with the running device by a chain or linkage assembly extending between the pull head and the running device.

Next, the method is comprised of the step of retracting the running device through the borehole toward the proximal borehole end so that the pipe assembly moves through the borehole toward the proximal borehole end. As the running device is retracted through the borehole, the running device concurrently pulls the pipe assembly within and through the borehole as a result of the connection of the pipe assembly with the running device. When the running device exits from or passes out of the proximal borehole end, the pipe is substantially in the desired position within the borehole although minor adjustments of the positioning of the pipe may be done if required.

Once the pipe is in the desired position in the borehole, the method comprises the step of disconnecting the pipe assembly from the running device. The pipe assembly may be disconnected in any suitable manner depending upon the manner in which the pipe assembly was initially connected with the running device. For instance, the method may include the step of disconnecting the pull head from the pipe assembly after the step of retracting the running device through the borehole. Disconnection of the pull head from the pipe assembly will necessarily result in the disconnection of the pipe assembly from the running device.

Preferably, the method is comprised of the step of uncoupling the pipe from the flexible sleeve after the step of retracting the running device through the borehole. Thus, in the preferred embodiment, the coupler is removed. In the words, the outer member is disconnected from the inner member by removing the plurality of fasteners. Then, the pull head may be removed from the end of the inner member. Specifically, the pull head may be cut from the end of the inner member at the point of the welding between the pull head and the inner member. Alternately, the inner member with the pull head connected thereto may be removed from the end of the pipe as a unit. Thus, the inner member may be cut from the end of the pipe at the point of the welding of the inner member to the pipe to thereby disconnect the pipe assembly from the running device.

Finally, in a third aspect of the invention, the invention is comprised of an apparatus or a system for installing a pipe in a borehole. The apparatus or system is comprised of a pipe assembly and the coupler as described herein. Further, the apparatus or system is also preferably comprised of the assembly mechanism for assembling the pipe assembly as described herein. As well, the apparatus or the system may be comprised of a means or mechanism for performing one or more of the further steps of the method described herein. Finally, the apparatus or the system may be comprised of one or more of the further components or elements of the pipe assembly described herein.

### SUMMARY OF DRAWINGS

Embodiments of the invention will now be described with reference to the accompanying drawings, in which:

FIG. 1 is a pictorial view of a running device drilling a borehole as the running device advances from a proximal borehole end toward the distal borehole end for connection with a pipe assembly of the within invention;

FIG. 2 is a pictorial view of the running device as shown in FIG. 1, wherein the running device extends from the distal borehole end for connection with the pipe assembly;

FIG. 3 is a pictorial view of the running device as shown in FIG. 1 retracting through the borehole toward the proximal borehole end, wherein the pipe assembly is connected with the running device;

FIG. 4 is a longitudinal sectional view of a pipe comprising the pipe assembly of the within invention, wherein the pipe is comprised of a protective coating;

FIG. 5 is a longitudinal sectional view of the pipe assembly comprising the pipe shown in FIG. 4 and a flexible sleeve surrounding the pipe;

FIG. 6 is a pictorial view of an assembly mechanism for assembling the pipe assembly by insertion of the pipe within the flexible sleeve;

FIG. 7 is a further pictorial view of the assembly mechanism shown in FIG. 6, wherein the assembly mechanism is in use to insert the pipe within the flexible sleeve;

FIG. 8 is a detailed pictorial view of the assembly mechanism shown in FIG. 6, wherein the flexible sleeve is secured thereto;

FIG. 9 is an exploded side view of the pipe assembly including a preferred embodiment of a coupler for holding the flexible sleeve on the pipe and a pull head for connection with the pipe assembly;

FIG. 10 is a side view of the pipe assembly shown in FIG. 9, wherein the pipe is connected with an inner member of the coupler;

FIG. 11 is a side view of the pipe assembly shown in FIG. 9, wherein an outer member of the coupler is being connected with the inner member such that the flexible sleeve is disposed between the inner and outer members of the coupler;

FIG. 12 is a side view of the pipe assembly shown in FIG. 9, wherein the outer member is connected with the inner member such that the flexible sleeve is disposed therebetween and wherein the pull head is connected with the pipe;

FIG. 13 is an exploded cross-sectional view of the pipe assembly taken along lines 13-13 of FIG. 11; and

FIG. 14 is a cross-sectional view of the pipe assembly taken along lines 14-14 of FIG. 12.

### DETAILED DESCRIPTION

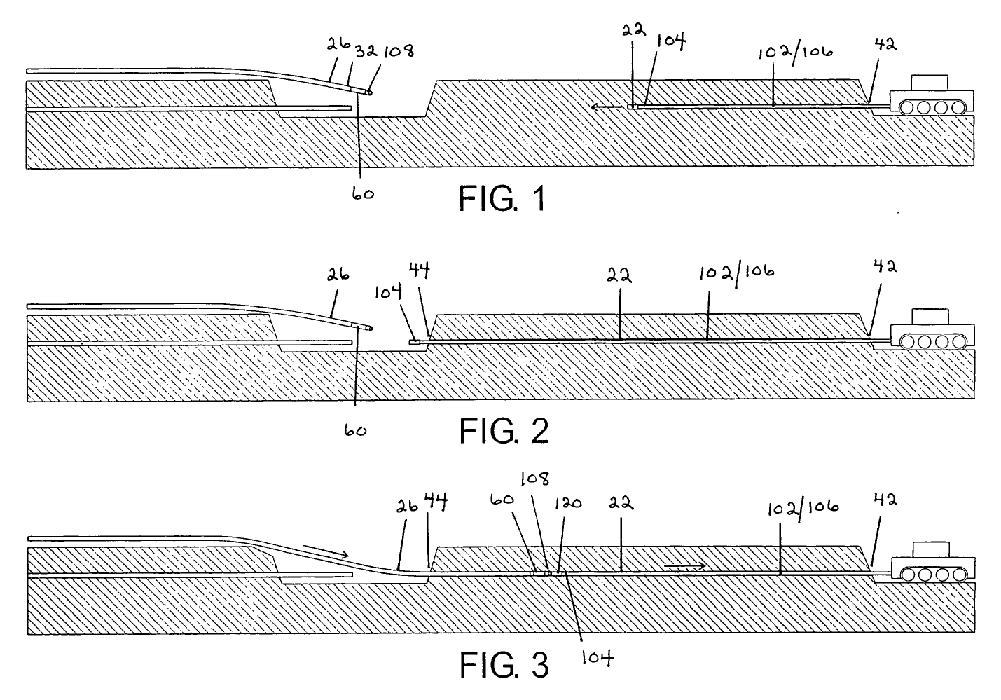

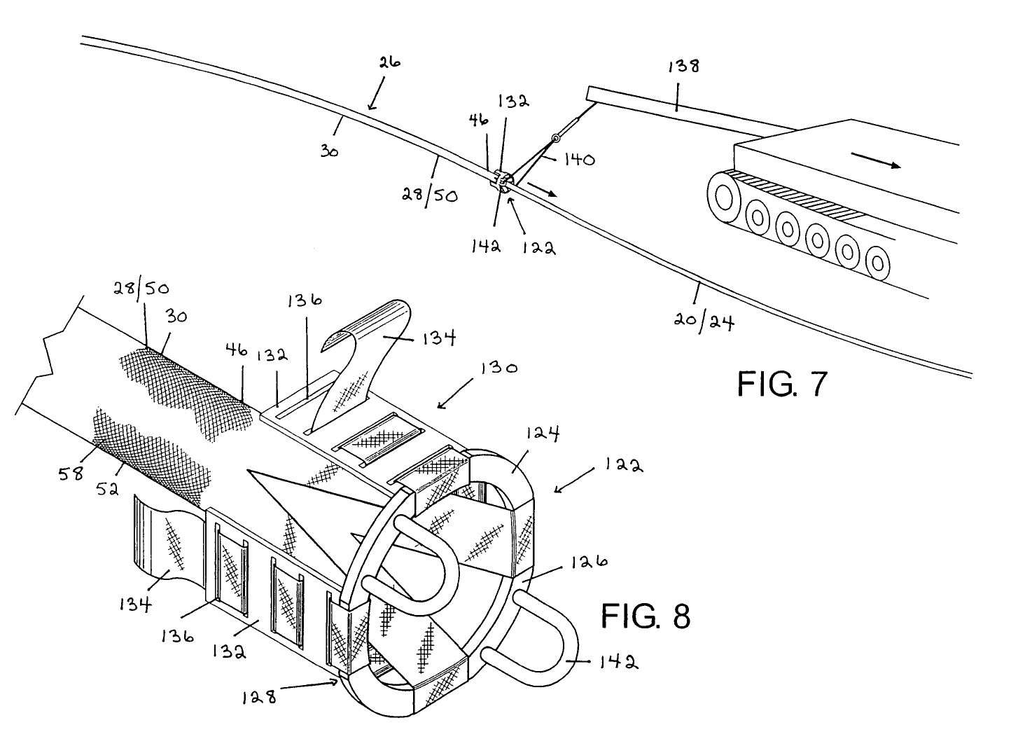

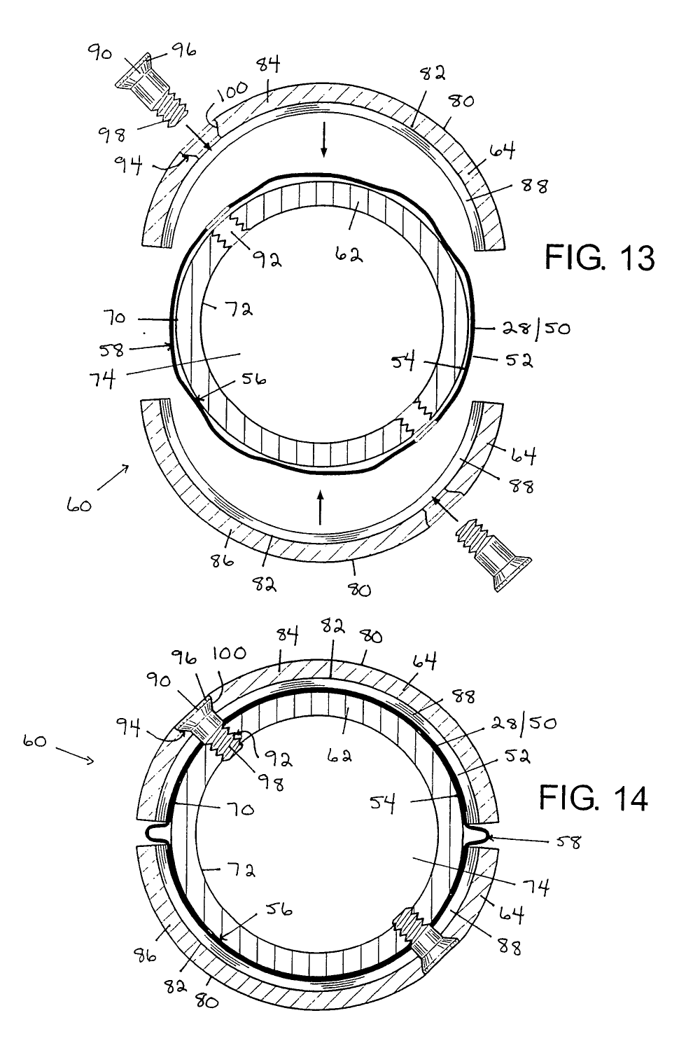

Referring to FIGS. 1-14, the within invention relates to a method for installing a pipe (20) in a borehole (22), wherein the pipe (20) is preferably comprised of a protective coating (24). In the preferred embodiment, the method is comprised of installing the pipe (20) in the borehole (22) as a component of a pipe assembly (26), wherein the pipe assembly (26) is comprised of the pipe (20) and a flexible sleeve (28) surrounding pipe (20). In addition, the within invention is comprised of the pipe assembly (26) for installation in the borehole (22). The method of installation and the pipe assembly (26) aim at reducing the likelihood of impact, collision or abrasion damage occurring to the pipe (20) or the protective coating (24) during its installation in the borehole (22).

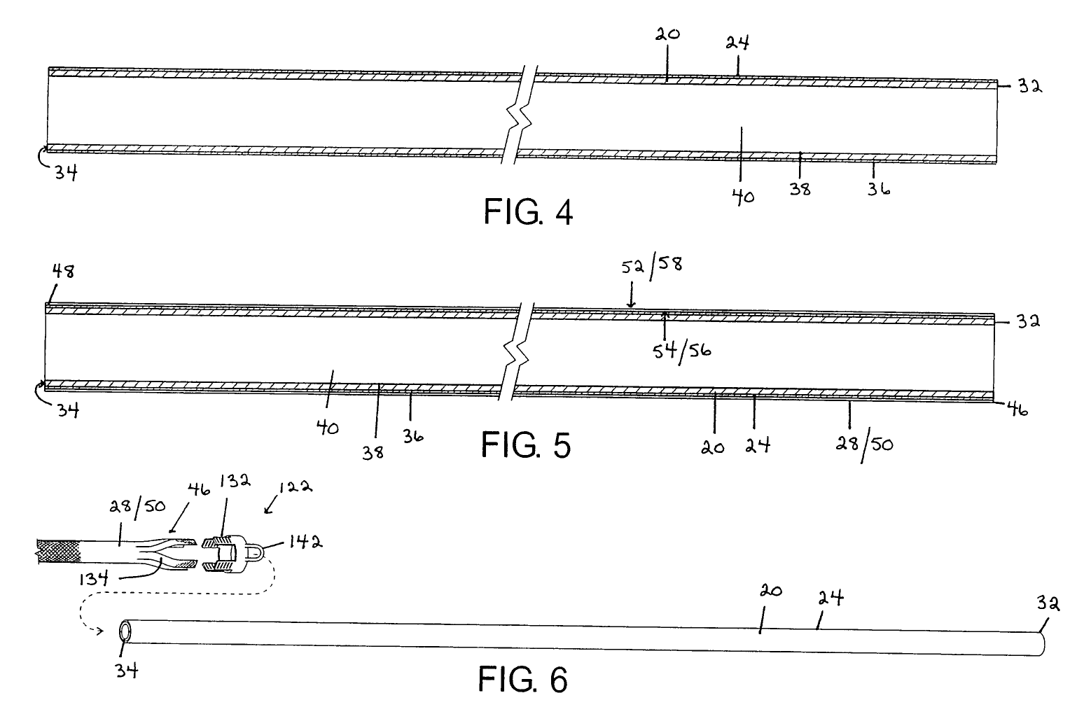

As stated, in the preferred embodiment, as particularly shown in FIGS. 4 and 5, the pipe assembly (26) is comprised of the pipe (20) and the flexible sleeve (28) surrounding the pipe (20). More particularly, the pipe (20) is comprised of the protective coating (24) and the flexible sleeve (28) is comprised of a continuous length of a flexible sleeve material (30).

Referring to FIGS. 4-6, the pipe (20) is preferably comprised of an elongate hollow cylindrical or tubular member or structure suitable for installation in the borehole (22). Preferably, the pipe (20) is comprised of fiberglass or a metal compatible with and suitable for the intended use of the pipe (20). In the preferred embodiment, the pipe (20) is comprised of a metal, particularly steel.

The pipe (20) has a first pipe end (32) and an opposed second pipe end (34) defining a pipe length therebetween. In addition, the pipe (20) has an outer surface (36) and an inner surface (38) defining a bore (40) of the pipe (20) which extends between the first pipe end (32) and the second pipe end (34). The bore (40) of the pipe (20) provides a passage for fluids or a conduit for electrical wires, cables or other desired structures to extend therethrough.

Preferably, the pipe (20) is comprised of a single unitary tubular or hollow cylindrical member extending between the first and second pipe ends (32, 34). However, the pipe (20) may alternately be comprised of two or more tubular or hollow cylindrical members or pipe sections connected, fastened or mounted together. In this case, the pipe sections are preferably rigidly connected, fastened or otherwise mounted together in a manner such that a sealed connection is provided to inhibit the passage of fluids out of the pipe bore (40) or the passage of deleterious substances or fluids into the pipe bore (40) at the connection point or location. Preferably, in this case, the adjacent ends of the pipe sections are fastened together by welding.

The length of the pipe (20) is selected to be compatible with the intended application or use of the pipe (20) as well as the borehole (22) into which the pipe (20) is to be installed. Particularly, as described further below, the length of the pipe (20) is selected such that the first and second pipe ends (32, 34) may extend from the opposed ends of the borehole (22) following the installation of the pipe (20) in the borehole (22). However, in the preferred embodiment, the length of the pipe (20) may be any length up to about 1000 feet (about 305 meters).

In addition, the outer surface (36) of the pipe (20) defines a outer circumference of the pipe (20) and a diameter of the pipe (20). The diameter of the pipe (20) is also selected to be compatible with the intended application or use of the pipe (20) as well as the borehole (22) into which the pipe (20) is to be installed. Particularly, the diameter of the pipe (20) is selected such that the pipe (20) may be inserted within and advanced through the borehole (22) as described further below. In the preferred embodiment, the diameter of the pipe (20) is in a range of about 3-12 inches (about 7.62-30.48 cm).

Referring to FIGS. 1-3, the borehole (22) is comprised of a proximal borehole end (42) and an opposed distal borehole end (44) defining a length of the borehole (22) therebetween. Preferably, the borehole (22) extends beneath the ground surface between the first and second borehole ends (42, 44), wherein the first and second borehole ends (42, 44) are each located or positioned at or adjacent to the ground surface or within a pocket or surface excavation permitting ready or relatively easy access to the proximal and distal borehole ends (42, 44). Thus, the installation is a trenchless installation in which the borehole (22) is accessible through the borehole ends (42, 44). Preferably, the borehole (22) is relatively superficially positioned beneath the ground surface such as at a depth of less than about 100 feet (30.48 meters) and preferably at a depth of about 10-20 feet (about 3.048-6.096 meters).

As stated, the length of the pipe (20) and the length of the borehole (22) are selected to be compatible with each other such that the pipe (20) may be installed within the borehole (22) in the desired manner. Particularly, in the preferred embodiment, following installation of the pipe (20) in the borehole (22), the first and second pipe ends (32, 34) extend from the proximal and distal borehole ends (42, 44) respectively. Thus, the pipe ends (32, 34) may be accessed following the installation of the pipe (20) as required depending upon the particular application or intended use of the pipe (20)

In addition, the borehole (22) defines an inner circumference of the borehole (22) and a diameter of the borehole (22). The diameter of the pipe (20) and the diameter of the borehole (22) are also selected to be compatible with each other such that the pipe (20) may be installed within the borehole (22) in the desired manner. As indicated, the relative diameters of the pipe (20) and the borehole (22) are selected such that the pipe (20) may be inserted within and advanced through the borehole (22).

Further, in the preferred embodiment, as discussed above, the pipe (20) is comprised of the protective coating (24). Preferably, the protective coating (24) is comprised of a corrosion-resistant substance or material applied to, spread upon or otherwise covering or overlying at least a portion of the pipe (20) to enhance the corrosion resistance of the underlying pipe (20) following its installation in the borehole (22). The protective coating (24) may be referred to as a “yellow-jacket.” Further, in the preferred embodiment, substantially the entire outer surface (36) of the pipe (20) is comprised of the protective coating (24). In other words, the protective coating (24) surrounds substantially the entire circumference of the pipe (20) and extends along substantially the entire length of the pipe (20).

The pipe assembly (26) is further comprised of the flexible sleeve (28). The flexible sleeve (2S) surrounds at least a portion of the pipe (20) and thus at least a portion of the protective coating (24). However, in the preferred embodiment as shown in FIG. 5, the flexible sleeve (28) surrounds substantially the entire outer surface (36) of the pipe (20) and its protective coating (24) along substantially the entire length of the pipe (20). In other words, the flexible sleeve (28) substantially covers or contains the pipe (20) and the protective coating (24). In the preferred embodiment, the flexible sleeve (28) is provided to enhance the impact, collision or abrasion resistance of the pipe (20) and its protective coating (24) and thereby reduce the likelihood of any damage occurring to the pipe (20) or the protective coating (24) during installation in the borehole (22).

The flexible sleeve (28) is comprised of a flexible sleeve material (30). The flexible sleeve material (30) is selected to permit an amount of bending, deflection or movement of the pipe (20) therein which would typically be anticipated to occur or which is likely to occur during the insertion and advancement of the pipe assembly (26) into and through the borehole (22). The flexible sleeve material (30) allows the desired amount of bending, deflection or movement of the pipe (20) without damaging, cracking or breaking the flexible sleeve (28). The flexible sleeve material (30) also facilitates the assembly of the pipe assembly (26) by insertion of the pipe (20) within the flexible sleeve (28), as described further below.

The flexible sleeve material (30) defines a first sleeve end (46) and an opposed second sleeve end (48) of the flexible sleeve (28). Further, a length of the flexible sleeve (28) is defined between the first and second sleeve ends (46, 4S). In the preferred embodiment, the flexible sleeve (28) is comprised of a continuous length of the flexible sleeve material (30) extending between the first and second sleeve ends (46, 48). In other words, the flexible sleeve (28) is comprised of a single or unitary section or portion of the flexible sleeve material (30) extending for the length of the flexible sleeve (28).

In addition, in the preferred embodiment, the flexible sleeve material (30) is seamless. Accordingly, in the preferred embodiment, the flexible sleeve (28) is comprised of a continuous length of a seamless flexible sleeve material (30). In other words, the flexible sleeve (28) preferably does not include any longitudinal, circumferential or other seams or joins within the flexible sleeve material (30).

The shape, size and configuration of the flexible sleeve (28) are selected and adapted to be compatible with the pipe (20) such that the pipe (20) is receivable therein. Preferably, the pipe (20) is readily or relatively easily received within the flexible sleeve (28). Accordingly, given the cylindrical or tubular nature of the pipe (20), the flexible sleeve (28) also preferably has a tubular or cylindrical shape.

As a result, in the preferred embodiment, the flexible sleeve (28) is comprised of a length of a hose (50). Accordingly, as discussed above, the length of the hose (50) is both continuous and seamless. Although any type of hose (50) having the desired characteristics may be used, in the preferred embodiment, the flexible sleeve (28) is comprised of a length of an industrial hose, such as a fire hose. It has been found that various types of Niedner® fire hose are suitable for use as the flexible sleeve (28) of the within invention. Niedner® is a registered trade-mark in Canada registered by Niedner Limited. However, any industrial hose, including any fire hose, having the properties or characteristics described below may be used as the flexible sleeve (28).

The flexible sleeve (28), and thus the hose (50) in the preferred embodiment, has an outer surface (52) and an inner surface (54), wherein the outer surface (52) defines a diameter of the flexible sleeve (28). The diameter of the flexible sleeve (28) is selected to permit the pipe (20) to be received within the inner surface (54) of the flexible sleeve (28). In addition, the diameter of the flexible sleeve (28) preferably provides for a relatively snug or close fit between the inner surface (54) of the flexible sleeve (28) and the outer surface (36) of the pipe (20) including the protective coating (24), while still permitting the pipe (20) to be readily or relatively easily inserted within the flexible sleeve (28) to assemble the pipe assembly (26).

As discussed above, the length of the flexible sleeve (28) is also selected to be compatible with the length of the pipe (20) to be received therein. In the preferred embodiment, the flexible sleeve (28) surrounds the pipe (20) along substantially the entire length of the pipe (20). Thus, the length of the flexible sleeve (28) is preferably at least about equal to the length of the pipe (20) which is to be installed within the borehole (22) or which will advance through the borehole (22) during the installation process. In the preferred embodiment, the length of the flexible sleeve (28) is greater than the length of the pipe (22) such that the first and second sleeve ends (46, 48) extend from the first and second pipe ends (32, 34) respectively a sufficient amount to permit the connection of a coupler or a coupling device to the pipe end as described further below.

Thus, as with the length of the pipe (20) discussed above, in the preferred embodiment, the flexible sleeve (28) may also be any length up to about 1000 feet (about 305 meters). Preferably, the length of the flexible sleeve (28), being a length of hose (50) in the preferred embodiment, is supplied in the form of a roll of hose (50) for assembly with the pipe (20) at the installation site or the borehole (22) location.

Preferably, the flexible sleeve material (30), and thus the hose (50), is comprised of a woven material. The woven material is selected to provide the desired flexibility of the flexible sleeve (28) as discussed above, as well as provide the desired amount or degree of impact, collision or abrasion resistance to the pipe (20) positioned therein. Finally, the selected woven material must have sufficient strength and durability to facilitate or be compatible with the insertion of the flexible sleeve (28) within the borehole (22) and the advancement of the flexible sleeve (28) through the borehole (28) by the preferred mechanisms and methods described herein. In the preferred embodiment, the woven material comprising the flexible sleeve (28) is comprised of a woven polyester material. With reference to the hose (50), the hose (50) is also comprised of a woven polyester material which may be referred to herein as a woven polyester hose material.

The woven polyester material may have any type of weave capable of and suitable for providing the desired qualities or characteristics of the flexible sleeve (28) or the hose (50) including the desired flexibility, impact or abrasion resistance and smoothness of the inner surface (54). For instance, in the preferred embodiment, the woven polyester material is circular woven or woven in a continuous circular fashion such that the flexible sleeve material (30) is continuous and seamless.

Further, the woven polyester material comprising the flexible sleeve (28), and the hose (50) in the preferred embodiment, may have either a plain weave, also referred to as a straight weave, or a twill weave, also referred to as a bias weave. The plain or straight weave is woven in a square fashion with the weft and warp threads or fibers at right angles to each other. In the plain weave, 50% of the warp fabric typically covers the outer surface (52) of the flexible sleeve (28) or hose (50) and 50% of the warp fabric covers the inner surface (54) of the flexible sleeve (28) or hose (50). In the twill or bias weave, ⅔ or 66% of the warp fabric is on the outer surface (52) of the flexible sleeve (28) or hose (50). It is for this reason, at least in part, that a twill weave tends to be relatively more flexible, more abrasion resistant and more rugged than a comparable plain weave. Accordingly, in the preferred embodiment, the flexible sleeve material (30) of the flexible sleeve (28) or the hose (50) is comprised of a twill weave woven polyester material, also referred to herein as a twill weave woven polyester hose material.

Woven material is typically provided in one or more layers or jackets of woven material. Thus, the flexible sleeve material (30) of the flexible sleeve (28) or the hose (50) may be comprised of one or more layers or jackets of woven material. Preferably, the flexible sleeve material (30) is comprised of at least one layer or jacket of the twill weave woven polyester material. In the preferred embodiment, the flexible sleeve material (30) is comprised of two layers or jackets of the twill weave woven polyester material, wherein one jacket is closely or snugly received within the other jacket to form the flexible sleeve (28) or the hose (50). In this case, the outermost layer or jacket defines the outer surface (52) of the flexible sleeve (28) or hose (50), while the innermost layer or jacket defines the inner surface (54) of the flexible sleeve (28) or hose (50).

In addition, in the preferred embodiment, the flexible sleeve material (30) is further comprised of a thermoplastic polyurethane material (56), also referred to as a thermoplastic urethane material. More particularly, the inner surface (54) of the flexible sleeve (28), and thus the hose (50), is comprised of a thermoplastic polyurethane material (56). Preferably, the thermoplastic polyurethane material (56) is integrally formed with the inner surface (54) or is fixedly secured or fastened to the inner surface (54) such that the thermoplastic polyurethane material (56) forms an integral part thereof. For instance, the thermoplastic polyurethane material (56) may be applied or spread upon the inner surface (54) or extruded within the inner surface (54) such that the thermoplastic polyurethane material (56) is closely or intimately associated with the inner surface (54). Thus, the thermoplastic polyurethane material (56) provides or forms a sleeve lining. It is believed that the thermoplastic polyurethane material (56) facilitates the assembly of the pipe assembly (26) by facilitating the insertion of the pipe (20) within the flexible sleeve material (30).

As well, the outer surface (52) of the flexible sleeve (28), and thus the hose (50) may be comprised of a sleeve coating or a sleeve coating material (58). Preferably, the sleeve coating material (58) is integrally formed with the outer surface (52) or is fixedly secured or fastened to the outer surface (52) such that the sleeve coating material (58) forms an integral part thereof. For instance, the outer surface (52) of the flexible sleeve (28) or the hose (50) may be impregnated or saturated with the sleeve coating material (58). In the preferred embodiment, the sleeve coating material (58) is comprised of a polymeric dispersion or a polymeric treatment commercially available under the trade-mark ENCAP® registered in Canada by Niedner Limited. It is believed that the sleeve coating material (58) enhances the abrasion resistance of the flexible sleeve material (30) and may increase the rigidity of the flexible sleeve material (30) where necessary such that the desirable degree or amount of flexibility of the flexible sleeve material (30) may be achieved.

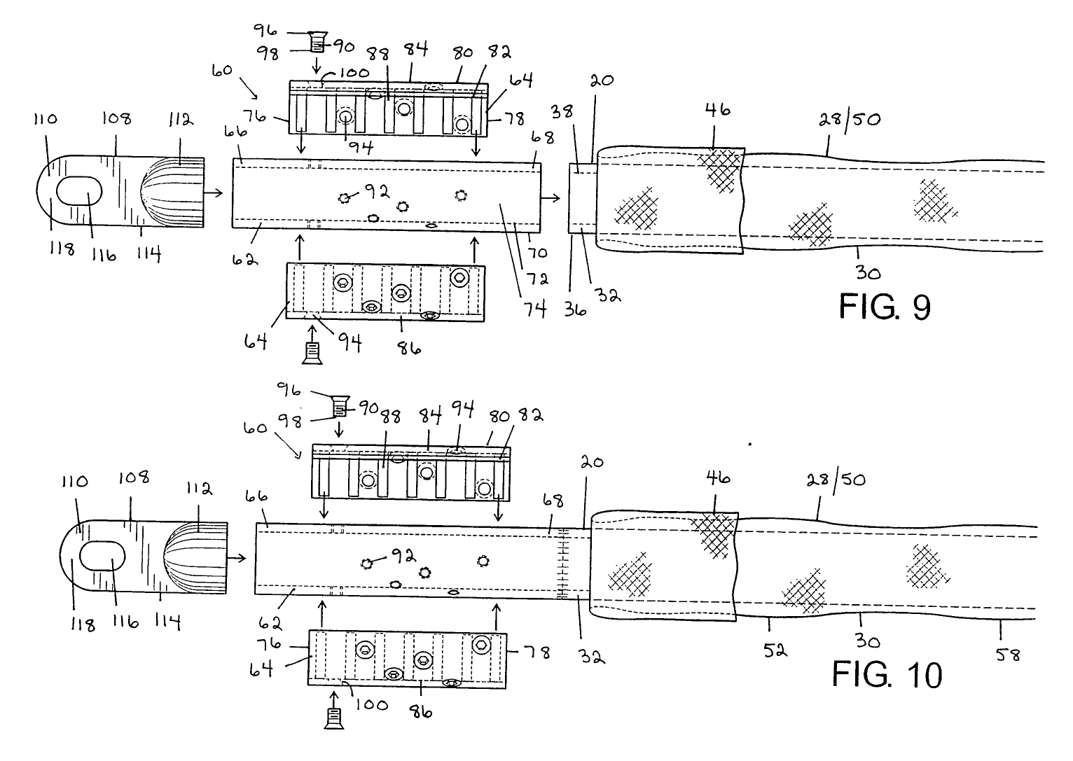

Referring to FIGS. 9-14, the pipe assembly (26) is also preferably comprised of a coupler (60) for holding the flexible sleeve (28), and thus the hose (50) in the preferred embodiment, on the pipe (20) so that the flexible sleeve.(28) is inhibited or prevent from moving relative to the pipe (20) as the pipe assembly (26) is advanced within the borehole (22). Further, although the coupler (60) may couple, link or join the flexible sleeve (28) with the pipe (20) at any location or position along the length of the flexible sleeve (28) permitting the coupler (60) to perform its function, the coupler (60) is preferably located or positioned at, adjacent or in proximity to one of the first and second sleeve ends (46, 48). Specifically, in order to hold the flexible sleeve (28) in position on the pipe (20), the coupler (60) is associated with the sleeve end which is to be first inserted within the borehole (22).

In the preferred embodiment, the coupler (60) is located or positioned at, adjacent or in proximity to the first sleeve end (46). Further, in the preferred embodiment, the flexible sleeve (28) surrounds the pipe (20) along substantially the entire length of the pipe (20). Accordingly, in the preferred embodiment, when the pipe (20) is assembled in the flexible sleeve (28), the first and second sleeve ends (46, 48) are positioned adjacent or in proximity to the first and second pipe ends (32, 34) respectively. As a result, the coupler (60) is also located or positioned at, adjacent or in proximity to the first pipe end (32).

The coupler (60) is preferably adapted or configured to permit the flexible sleeve (28) to be readily or relatively easily coupled with and uncoupled from the pipe (20) at the installation site or borehole (22) location. Thus, in the preferred embodiment, the coupler (60) is comprised of an inner member (62) which is releasably or removably connectable or fastenable with a compatible or corresponding outer member (64) in the manner described herein.

More particularly, the inner member (62) is connectable with an end of the pipe (22), preferably the first pipe end (32). As stated above, in the preferred embodiment, the length of the flexible sleeve (2S) is somewhat greater than the length of the pipe (22) such that the first sleeve end (46) extends from the first pipe end (32) a sufficient amount or distance to permit the connection of the coupler (60). More particularly, the first sleeve end (46) preferably extends from the first pipe end (32) for about the length of the inner member (62) of the coupler (60) connected with the first pipe end (32). As a result, when the pipe assembly (26) is properly assembled, the flexible sleeve (28) substantially surrounds the inner member (62) along substantially its entire length. The outer member (64) is then releasably or removably connected with the inner member (62) such that the flexible sleeve (28) or the hose (50) is disposed between the inner and outer members (62, 64) of the coupler (60).

Accordingly, although the flexible sleeve (28) preferably extends along substantially the entire length of the inner member (62), it may extend for a lesser amount or length so long as at least a portion of the flexible sleeve (28) may be disposed between the inner and outer members (62, 64). In any event, a sufficient portion or length of the flexible sleeve (2S) must be disposed between the inner and outer members (62, 64) to permit the coupler (60) to perform its function and securely hold the flexible sleeve (28) to the pipe (20).

The inner member (62) has a first end (66) and an opposed second end (68) which define a length of the inner member (62) therebetween. Preferably, the inner member (62) is comprised of a single unitary elongate tubular or cylindrical member extending for the desired length of the inner member (62). Accordingly, the inner member (62) has a compatible shape for connection with the pipe (20). Preferably, either of the first or second ends (66, 68) of the inner member (62) is connected with the first pipe end (32). In the preferred embodiment, the second end (68) of the inner member (62) is connected with the first pipe end (32) such that the inner member (62) acts as or provides an extension to the pipe (20).

Further, the inner member (62) has an outer surface (70) defining a diameter of the inner member (62) and an opposed inner surface (72) defining a bore (74) of the inner member (62) extending between the first and second ends (66, 68). As stated, the inner member (62) preferably has a compatible shape and configuration for connection with the pipe (20). Thus, in the preferred embodiment, the diameter of the inner member (62) is substantially similar to the diameter of the pipe (20). Accordingly, the outer surface (70) of the inner member (62) and the outer surface (36) of the pipe (20) are substantially continuous when the second end (6S) of the inner member (62) is connected with the first end (32) of the pipe (20). Further, the inner surface (38) of the pipe (20) is preferably substantially continuous with the inner surface (72) of the inner member (62) such that the bore (40) of the pipe (20) communicates with the bore (74) of the inner member (62).

The inner member (62) may have any desired length. However, as stated, preferably a length is selected such that the flexible sleeve (28) may extend from the first end (32) of the pipe (20) to surround at least a portion of the length of the inner member (62), and more preferably, to surround substantially the entire length of the inner member (62). Preferably, the inner member (62) has a length of between about 12 inches (30.48 cm) and 36 inches (91.44 cm). In the preferred embodiment, the inner member (62) has a length of about 24 inches (60.96 cm).

Further, the inner member (62) is preferably comprised of a material compatible with, and suitable for, connection with the pipe (20) in the desired manner. As well, the material comprising the inner member (62) must be compatible with the method of installation of the pipe (20) in the borehole (22). Preferably, the inner member (62) of the coupler (60) is comprised of fiberglass or a metal. In the preferred embodiment, the inner member (62) is comprised of a metal, particularly steel.

The adjacent first and second ends (32, 6S) of the pipe (20) and the inner member (62) respectively may be releasably or removably connected together such as by a threaded connection therebetween. However, preferably, the pipe (20) and the inner member (62) are more rigidly or securely mounted, fastened or otherwise connected together so that the ends (32, 68) may not be readily disconnected. In the preferred embodiment, the adjacent first end (32) of the pipe (20) and the second end (68) of the inner member (62) are welded together. Specifically a butt weld is provided between the adjacent surfaces to connect the inner member (62) of the coupler (60) with the pipe (20) as shown in FIG. 10.

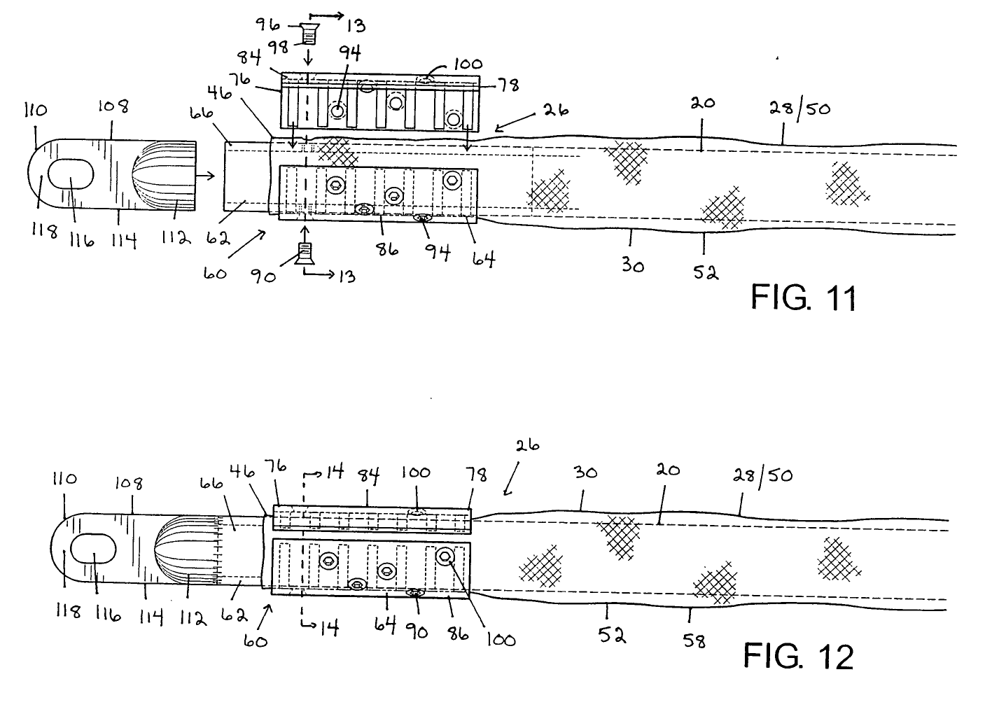

Once the inner member (62) is connected with the pipe (20) as shown in FIG. 10, the flexible sleeve (28) is disposed about the inner member (62) as shown in FIG. 11 in order that the outer member (64) may be connected with the inner member (62) with the flexible sleeve (28) disposed therebetween.

The outer member (64) is adapted for connection with the inner member (62) having the flexible sleeve (28) or hose (50) disposed therebetween. Thus, the outer member (64) has a shape and configuration compatible with the inner member (62) such that the outer member (64) may be connected with the inner member (62) to securely hold the flexible sleeve (28) in the desired position relative to the pipe (20).

The outer member (64) has a first end (76) and an opposed second end (78) which define a length of the outer member (64) therebetween. Further, the outer member (64) has an outer surface (80) and an opposed inner surface (82). The inner surface (82) of the outer member (64) is particularly adapted to receive the inner member (62) therein such that the flexible sleeve (28) is disposed between and firmly or securely held by the inner surface (82) of the outer member (64) and the outer surface (70) of the inner member (62).

In the preferred embodiment, the outer member (64) is comprised of two complementary clamping members or shell components which act together to hold the flexible sleeve (28) in position. Specifically, the outer member (64) is comprised of a first shell member (84) and a complementary second shell member (86). Each of the first and second shell members (84, 86) extends longitudinally for the entire length of the outer member (64) between the first and second ends (76, 78). Further, each of the first and second shell members (84, 86) comprises a portion of the inner surface (82) of the outer member (64) for engaging the flexible sleeve (28). When mounted or connected with the inner member (62), each of the first and second shell members (84, 86) extends circumferentially about a portion of the outer surface (70) of the inner member (62). In the preferred embodiment, the first and second shell members (84, 86) together extend circumferentially about substantially the entire outer surface (70) of the inner member (62) as shown in FIGS. 12 and 14. However, the adjacent longitudinal side edges of the first and second shell members (84, 86) may be a spaced distance apart where required to provide an amount of space for receiving any excess flexible sleeve material (30), as shown in FIG. 14. Finally, although the specific dimensions or configuration of each-of the first and second shell members (84, 86) may differ, the first and second shell members (84, 86) are preferably substantially similar.

When mounted or connected with the inner member (62), the first and second shell members (84, 86) together form an elongate tubular or cylindrical outer member (64) for engaging the flexible sleeve (28). Thus, in the preferred embodiment, each of the first and second shell members (84, 86) comprises a portion, and preferably ½, of the elongate tubular or cylindrical outer member (64). Further, each of the first and second shell members (84, 86) is comprised of a single unitary member, component or element extending between the first and second ends (76, 78) of the outer member (64) and providing a portion of the inner surface (82).

The length of the outer member (64) is selected such that the inner surface (82) may engage the flexible sleeve (28) sufficiently to securely or firmly hold the flexible sleeve (28) in position between the inner surface (82) of the outer member (64) and the outer surface (70) of the inner member (62) of the coupler (60). Further, the length of the outer member (64) is selected to be compatible with the length of the inner member (62). Preferably, the length of the outer member (64) is about equal to or less than the length of the inner member (62). In the preferred embodiment, the outer member (64) has a length of about 12 inches (30.48 cm).

The outer member (64) is comprised of a material compatible with the method of installation of the pipe (20) in the borehole (22) such that the outer member (64) is capable of withstanding the conditions to which it is likely to be exposed during the advancement of the pipe assembly (26) through the borehole (22). Further, the outer member (64) is comprised of a material compatible with the mechanism or means provided for connecting the inner and outer members (62, 64). In the preferred embodiment, the outer member (64) of the coupler (60), including the first and second shell members (84, 86), is comprised of fiberglass or a metal. In the preferred embodiment, the outer member (64) is also comprised of a metal, particularly steel.

The first and second shell members (84, 86) are connectable with the inner member (62) such that the inner surface (82) of the outer member (64) engages the flexible sleeve (28), and thus the hose (50) in the preferred embodiment. In the preferred embodiment, the inner surface (82) of the outer member (64) is further comprised of a gripping surface (88) The gripping surface (88) may form or comprise all or a portion of the inner surface (82) and is provided for resisting movement of the flexible sleeve material (30) relative to the inner surface (82). Thus, the gripping surface (88) enhances or facilitates the engagement of the inner surface (82) and the flexible sleeve material (30).

Preferably, the gripping surface (88) is comprised of a gripping substance or material capable of enhancing or increasing the friction between the adjacent inner surface (82) of the outer member (64) and flexible sleeve material (30) or capable of enhancing or aiding the distribution of the compressive force applied by the outer member (64) against the flexible sleeve material (30) to resist its movement. In other words, a compression fitting is preferably provided between the inner and outer members (62, 64) which is enhanced or aided by the gripping surface (88). As stated, the entire inner surface (82) or any part thereof may comprise or form the gripping surface (88). For instance, as shown in FIGS. 9-12, the gripping surface (88) comprises a portion of the inner surface (82) and is formed or applied circumferentially in strips or sections to the inner surface (82). In the preferred embodiment, the gripping surface (88) is comprised of rubber. The rubber acts to grip the flexible sleeve material (30) and to distribute the forces applied to the flexible sleeve (2S) and the inner member (62). As shown in FIGS. 9-12, the rubber may be applied in strips or sections circumferentially to the inner surface (82) or it may be applied to the entire inner surface (82).

In the preferred embodiment, the coupler (60) is further comprised of a plurality of fasteners (90), as shown in FIGS. 9-14, for releasably or removably connecting the outer member (64) with the inner member (62). Any number of fasteners (90) may be used which is capable of securely connecting the inner and outer members (62, 64) as described herein. Each of the fasteners (90) extends between the inner and outer members (62, 64) through the flexible sleeve material (30) disposed therebetween. The plurality of fasteners (90) may be positioned longitudinally or axially along the length of the outer member (64) and circumferentially about the outer member (64) in any pattern capable of securely or firmly connecting the inner and outer members (62, 64). However, it has been found that in order to inhibit or minimize any tearing or damage to the flexible sleeve material (30) incurred by the fasteners (90), the plurality of fasteners (90) is preferably arranged in a staggered configuration such that none of the fasteners (90) are longitudinally aligned or aligned along the longitudinal axis of the pipe (20) and thus the coupler (60).

In the preferred embodiment, the inner member (62) defines a plurality of holes (92) adapted and sized for receiving the plurality of fasteners (90) therein. Further, the outer member (64), including each of the first and second shell members (84, 88), defines a plurality of corresponding holes (94) also adapted for receiving the plurality of fasteners (90) therein. The holes (92, 94) defined by each of the inner and outer members (62, 64) are arranged such that the holes (92, 94) are capable of being aligned with each other when the outer member (64) is positioned on the inner member (62) in order that a fastener (90) may pass or extend between a hole (92) in the inner member (62) and a corresponding hole (94) in the outer member (64). Further, as discussed above, the holes (92, 94) in the inner and outer members (62, 64) are also preferably arranged in the staggered configuration such that none of the fasteners (90) received therein are longitudinally or axially aligned along the length or longitudinal axis of the coupler (60).

Any type of fastener (90) may be used to connect the inner and outer members (62, 64) such as a plurality of bolts or screws. In any event, each of the fasteners (90) includes an outer end (96) and an inner end (98). To position the fastener (90), the inner end (98) passes through the hole (94) in the outer member (64) for receipt in the corresponding hole (92) in the inner member (62). Further, the inner end (98) is engaged or secured in the hole (92) in the inner member (62). For instance, the inner end (98) of the fastener (90) may extend through the hole (92) in the inner member (62) and into the bore (74) of the inner member (62), wherein a nut or other member may be attached or affixed with the inner end (98) to hold the fastener (90) in position. Alternately, the inner end (98) may be threaded for engagement with a compatible thread within the hole (92) of the inner member (62). Preferably, the fasteners (90) are comprised of self-tapping screws.

In addition, when positioned within the holes (92, 94), the outer end (96) of the fastener (90) is preferably countersunk within the outer surface (80) of the outer member (64). In other words, the outer end (96) does not extend from the outer surface (80) in order to facilitate the passage of the pipe assembly (26) through the borehole (22). In the preferred embodiment, the outer surface (80) of the outer member (64) defines a recess (100) about or surrounding each hole (94) for receipt of the outer end (96) of the fastener (90) therein.

Referring to FIGS. 1-3, with respect to the method of installing the pipe (20) in the borehole (22), a running device (102) is advanced through the borehole (22) from the proximal borehole end (42) toward the distal borehole end (44). More particularly, the running device (102) has an advancing end (104) which is passed through the borehole (22) from the proximal borehole end (42) toward the distal borehole end (44). In the preferred embodiment, the borehole (22) is formed or drilled concurrently with the advancing of the running device (102) through the borehole (22). In other words, in the preferred embodiment, the running device (102) is advanced through the borehole (22) as the borehole (22) is drilled. Accordingly, the advancing end (104) of the running device (102) preferably drills the borehole (22) as it concurrently advances toward the distal borehole end (44).

As a result, the running device (102) is preferably comprised of an underground drilling, boring, reaming or augering device or apparatus capable of forming or drilling the borehole (22) from the proximal borehole end (42) to the distal borehole end (44) and later being retracted from the borehole (22) in the reverse direction. In the preferred embodiment, the running device (102) is comprised of a drilling assembly (106) for drilling the borehole (22), and preferably is comprised of a directional drilling assembly to permit the drilling of the borehole (22) in the desired location and direction. In this case, the advancing end (104) is comprised of a suitable drill bit for drilling the borehole (22) in the existing ground conditions.

The pipe assembly (26) is then connected with the running device (102) from the distal borehole end (44). Accordingly, the running device (102) is preferably advanced through the borehole (22) such that the advancing end (104) of the running device (102) is located at, adjacent or in proximity to the distal borehole end (44) for ease of access thereto. In the preferred embodiment, the advancing end (104) extends from the distal borehole end (44) for connection of the pipe assembly (26). The pipe assembly (26) is comprised of the pipe (20) and the flexible sleeve (28), or the hose (50) in the preferred embodiment, surrounding the pipe (20). In the preferred embodiment, the pipe assembly (26) is comprised of the preferred embodiment of the pipe assembly (26), as described herein.

The pipe assembly (26) is preferably connected with the running device (102) in a removable or releasable manner. In addition, the running device (102) may be connected with any portion or component of the pipe assembly (26). However, in the preferred embodiment, the pipe assembly (26) and the running device (102) are connected by a pull head (108) positioned between the pipe assembly (26) and the advancing end (104) of the running device (102). Specifically, a pull head (108) is connected with the pipe assembly (26) to facilitate the step of connecting the pipe assembly (26) with the running device (102). The pull head (108) permits the releasable connection of the pipe assembly (26) with the running device (102).

In the preferred embodiment, the pull head (108) is connected with the coupler (60) of the pipe assembly (26). More particularly, referring to FIGS. 9-12, the pull head (108) is connected with the inner member (62) of the coupler (60). The pull head (108) has a first end (110) and an opposed second end (112) which define a length of the pull head (108) therebetween. Preferably, the pull head (108) is comprised of a single unitary elongate member. The second end (112) of the pull head (1OS) is shaped and adapted for connection with the first end (66) of the inner member (62) of the coupler, while the first end (110) of the pull head (108) is adapted for connection directly or indirectly with the running device (102).

More particularly, the pull head (108) has an outer surface (114) defining a diameter of the pull head (108) at the second end (112). As stated, the second end (112) of the pull head (108) has a compatible shape and configuration for connection with the first end (66) of the inner member (62). Thus, in the preferred embodiment, the diameter of the pull head (108) at the second end (112) is substantially similar to the diameter of the inner member (62). Accordingly, the outer surface (114) of the pull head (108) at the second end (112) and the outer surface (70) of the inner member (62) are substantially continuous when the second end (112) of the pull head (108) is connected with the first end (66) of the inner member (62).

The adjacent first and second ends (66, 112) of the inner member (62) and the pull head (108) respectively may be releasably or removably connected together such as by a threaded connection therebetween. However, preferably, the inner member (62) and the pull -head (108) are more rigidly or securely mounted, fastened or otherwise connected together so that the ends (66, 112) may not be readily disconnected. In the preferred embodiment, the adjacent first end (66) of the inner member (62) and the second end (112) of the pull head (108) are welded together. Specifically a butt weld is provided between the adjacent surfaces to connect the pull head (108) with the inner member (62) of the coupler (60) as shown in FIG. 12.

The first end (110) of the pull head (108) preferably defines an orifice or slot (116) therein such that the first end (110) comprises a connecting loop (118) for connection with the running device (102). In the preferred embodiment, a clevis (120), pull chain or other linkage assembly or mechanism extends between the connecting loop (118) of the pull head (108) and the advancing end (104) of the running device (102) as shown in FIG. 3.

Finally, the pull head (108) is preferably comprised of a material compatible with, and suitable for, connection with the inner member (62) in the desired manner. As well, the material comprising the pull head (108) must be compatible with the method of installation of the pipe (20) in the borehole (22). In the preferred embodiment, the pull head (108) is comprised of fiberglass or a metal. In the preferred embodiment, the pull head (108) is comprised of a metal, particularly steel.

Following the connecting of the pipe assembly (26) with the running device (102) from the distal borehole end (44), the running device (102) is retracted through the borehole (22) toward the proximal borehole end (42) so that the pipe assembly (26) moves through the borehole (22) toward the proximal borehole end (42). As the running device (102), and thus the advancing end (104) of the running device (102) connected with the pull head (108), is retracted through the borehole (22), the running device (102) concurrently pulls the pipe assembly (26) within the distal borehole end (44) and through the borehole (22) toward the proximal borehole end (42).

When the running device (102), and particularly the advancing end (104), exits from or passes out of the proximal borehole end (42), the pipe assembly (26) extends substantially through the borehole (22) between the distal and proximal borehole ends (44, 42). Accordingly, the pipe (20) comprising the pipe assembly (26) is substantially in the desired position within the borehole (22) although minor adjustments of the positioning of the pipe -assembly (26) and the pipe (20) may be performed if required. The pipe assembly (26) may then be disconnected from the running device (102).

In the preferred embodiment, the pipe assembly (26) is disconnected from the running device (102) by releasing or disconnecting the clevis (120) extending between the advancing end (104) of the running device (102) and the connecting loop (11 8) of the pull head (108). Further, once the running device (102) is retracted through the borehole (22), the pull head (108) may also be disconnected from the pipe assembly (26). If not already done, as described above, disconnection of the pull head (108) from the pipe assembly (26) will also result in the disconnection of the pipe assembly (26) from the running device (102). In the preferred embodiment, the pull head (108) is disconnected from the pipe assembly (26) by cutting between or otherwise separating the first end (66) of the inner member (62) of the coupler (60) and the second end (112) of the pull head (108).

In addition, where the pipe assembly (26) is not already assembled for connection with the running device (102), the method includes the step of assembling the pipe assembly (26). The assembling step may be performed in any manner and by any process capable of positioning the pipe (20) within the flexible sleeve (28), or the hose (50) in the preferred embodiment, such that the flexible sleeve (28) surrounds the pipe (20) in the manner described above. In the preferred embodiment, the step of assembling the pipe assembly (26) is comprised of inserting the pipe (20) within a continuous length of the flexible sleeve (28) and preferably within a continuous length of the hose (50).

The pipe (20) may be inserted within the flexible sleeve (28) in any maimer and utilizing any type of assembly mechanism or device capable of inserting the pipe (20) in the desired manner within the flexible sleeve (28). However, in the preferred embodiment, an assembly mechanism (122) as particularly shown in FIGS. 6-8 is utilized.

Referring to FIGS. 6 and 8, the assembly mechanism (122) is comprised of a substantially circular ring portion (124) having a diameter compatible with the diameter of the pipe (20) such that the pipe (20) may readily or relatively easily pass through the ring portion (124). The ring portion (124) has an upper surface (126) and an opposed lower surface (126). The ring portion (124) as shown in FIGS. 6 and 8 is formed by or comprised of a single integral member or component. However, the ring portion (124) may alternately be comprised of or formed by two members or components which are connected or fastened together in any manner either permanently or releasably. In this case, the two members or components of the ring portion (124) are preferably connected by a hinge such that they may be readily released for easy removal of the assembly mechanism (122).

In addition, the assembly mechanism (122) is comprised of an arm portion (130),wherein the arm portion (130) is comprised of at least one, and preferably more than one, arm (132) or elongate member extending from the lower surface (128) of the ring portion (124). In the preferred embodiment, the arm portion (130) is comprised of four arms (132) integrally formed or rigidly or securely connected with the lower surface (128) of the ring portion (124). The arms (132) are preferably spaced about the circumference of the lower surface (128) of the ring portion (124). In the preferred embodiment, the arms (132) are substantially evenly spaced about the circumference of the lower surface (128) of the ring portion (124). In addition, the arms (132) extend from the lower surface (128) in a manner such that the arms (132) do not interfere with or impede the passage of the pipe (20) from the ring portion (124) and through the aim portion (130).

In the preferred embodiment, to assemble the pipe assembly (26), one of the first or second sleeve ends (46, 48) is connected, fastened or otherwise mounted with the arm portion (130) of the assembly mechanism (122). More preferably, the first sleeve end (46) is preferably releasably or removably connected with the arms (132) of the arm portion (130). In particular, the first sleeve end (46) is cut or split into four elongate strips (134) of the flexible sleeve material (30). The four strips (134) of the flexible sleeve material (30) are provided for connection with the corresponding four arms (132) of the assembly mechanism (122).

In the preferred embodiment, each of the arms (132) defines a plurality of slots (136) sized or configured and adapted for receipt of the strips (134) of the flexible sleeve material (30) therein as shown in FIG. 8. In particular, the flexible sleeve (28) is releasably connected with the assembly mechanism (122) by passing each of the strips (134) of the flexible sleeve material (30) at the first sleeve end (46) through the center of the arm portion (130) and subsequently through the center of the ring portion (124) to extend from the upper surface (126) of the ring portion (124). Each strip (134) is then folded outwardly over the upper surface (126) and then downwardly such that the strip (134) may be weaved through the slots (136) in the corresponding arm (132). The weaving of the strips (134) through the slots (136) secures the flexible sleeve (28) to the assembly mechanism (122) and positions the first sleeve end (46) for receipt of the pipe (20) therein.

Referring particularly to FIGS. 6-8, the assembly mechanism (122) is connected with the first sleeve end (46) in the manner described above. The second pipe end (34) is then inserted through the ring portion (124) of the assembly mechanism (122) from the upper surface (126) and between the arms (132) of the arm portion (130) of the assembly mechanism (122) such that second pipe end (34) passes within the first sleeve end (46). The assembly mechanism (122) is then pulled along the length of the pipe (20) from the second pipe end (34) towards the first pipe end (32). As the assembly mechanism (122) is pulled along the pipe (20), the flexible sleeve (28) is concurrently pulled by the assembly mechanism (122) into the desired position relative to the pipe (20) as described previously. The weight of the pipe (20) tends to counteract any movement of the pipe (20) in the direction of the movement of the assembly mechanism (122) to permit the flexible sleeve (28) to move relative to the pipe (20) and slide along the length of the pipe (20). Where necessary to facilitate the sliding of the flexible sleeve (2S) along the pipe (20), a lubricant such as a soap, may be applied to the outer surface (36) of the pipe (20).

Any apparatus or mechanism such as a tractor with a boom (138) may be used to pull the assembly mechanism (122) along the pipe (20). The boom (138) is connected with the assembly mechanism (122) by a chain (140), sling or other linking assembly or mechanism extending therebetween. The chain (140) may be connected or fastened with any portion of the assembly mechanism (122), however, the chain (140) is preferably connected or fastened with the ring portion (124). More particularly, the ring portion (124) is preferably comprised of at least one and preferably two handles or linking loops (142).

In the preferred embodiment, each of the handles or linking loops (142) extends outwardly from the upper surface (126) of the ring portion (124), wherein the handles or linking loops (142) are spaced evenly apart about the circumference of the ring portion (124) and positioned between two adjacent arms (132) so as to not interfere with the connection of the strips (134) of the flexible sleeve material (30) with the arms (132).

The assembly mechanism (122) may be comprised of any suitable material capable of pulling the flexible sleeve (28) along the pipe (20). In the preferred embodiment, the assembly mechanism (122) is comprised of a metal, preferably steel.

Once the pipe assembly (26) is assembled and the pipe (20) is positioned within the flexible sleeve (28), the assembly mechanism (122) is removed from the first sleeve end (46). The assembly mechanism (122) may be removed by weaving the strips (134) of the flexible sleeve material (30) out of the slots (136) in the arms (132) to release the flexible sleeve (28) from the arm portion (130) of the assembly mechanism (122). However, preferably, the strips (134) of the flexible sleeve material (30) are simply cut away from the first sleeve end (46) in order to remove the strips (134) from the flexible sleeve (28) and thus remove the assembly mechanism (122). In any event, the strips (134) of the flexible sleeve material (30) are preferably cut away or otherwise removed following the assembling step so that the strips (134) do not interfere with the subsequent use of the coupler (60) to couple the flexible sleeve (28) with the pipe (20).

In the method of the within invention, the pipe assembly (26) is assembled prior to connecting the pipe assembly (26) with the running device (102). Once the flexible sleeve (28) is positioned on the pipe (28), the flexible sleeve (28) is preferably coupled with the pipe (20) in a coupling step in order to hold the flexible sleeve (28) on the pipe (20) during the subsequent step of retracting the running device (102) through the borehole (22). The coupling step may be performed in any manner and by any type of coupler or coupling mechanism, device or structure as described above. However, in the preferred embodiment, the coupling step is performed utilizing the preferred coupler (60) as described herein. Thus, as shown in FIGS. 9-12, the coupling step is comprised of connecting the second end (68) of the inner member (62) of the coupler (60) with the first pipe end (32), disposing or placing the flexible sleeve material (30) over the inner member (62) and connecting the outer member (64) of the coupler (60) with the inner member (62) using the plurality of fasteners (90).

Following the retracting of the running device (102), once the pipe assembly (26) is in the desired position within the borehole (22), the method may include the further step of uncoupling the pipe (20) from the flexible sleeve (28). In other words, in the preferred embodiment, the coupler (60) is simply removed by reversing the steps outlined above. The outer member (64) is disconnected from the inner member (62) by removing the plurality of fasteners (90), retracting or pulling back the flexible sleeve material (30) to expose the first pipe end (32) and removing the inner member (62), such as by cutting, from the first pipe end (32).

The embodiments of the invention in which an exclusive property or privilege is claimed are defined as follows:

1. A method for installing a pipe in a borehole, wherein the borehole is comprised of a proximal borehole end and a distal borehole end, the method comprising the following steps:
(a) advancing a running device through the borehole from the proximal borehole end toward the distal borehole end;
(b) connecting a pipe assembly with the running device from the distal borehole end, wherein the pipe assembly is comprised of:
(i) the pipe; and
(ii) a flexible sleeve surrounding the pipe;
(c) retracting the running device through the borehole toward the proximal borehole end so that the pipe assembly moves through the borehole toward the proximal borehole end; and
(d) disconnecting the pipe assembly from the running device.

2. The method as claimed in claim 1 wherein the running device is comprised of a drilling assembly for drilling the borehole.

3. The method as claimed in claim 2 wherein the running device is advanced through the borehole as the borehole is drilled.

4. The method as claimed in claim 1 wherein the pipe is comprised of a protective coating.

5. The method as claimed in claim 1 wherein the flexible sleeve is comprised of a continuous length of a flexible sleeve material.

6. The method as claimed in claim 5 wherein the flexible sleeve material is seamless.

7. The method as claimed in claim 6 wherein the flexible sleeve material is comprised of a woven material.

8. The method as claimed in claim 6 wherein the flexible sleeve material is comprised of a woven polyester material.

9. The method as claimed in claim 6 wherein the flexible sleeve material is comprised of a twill weave woven polyester material.

10. The method as claimed in claim 8 wherein the flexible sleeve material is further comprised of a thermoplastic polyurethane material.

11. The method as claimed in claim 1 wherein the flexible sleeve is comprised of a length of a hose.

12. The method as claimed in claim 11 wherein the length of the hose is continuous and seamless.

13. The method as claimed in claim 12 wherein the hose is comprised of a woven polyester hose material.

14. The method as claimed in claim 12 wherein the hose is comprised of a twill weave woven polyester hose material.

15. The method as claimed in claim 13 wherein the hose is further comprised of a thermoplastic polyurethane material.

16. The method as claimed in claim 1 wherein the flexible sleeve is comprised of a length of an industrial hose.

17. The method as claimed in claim 1, further comprising the step of coupling the pipe with the flexible sleeve in order to hold the flexible sleeve on the pipe during the step of retracting the running device through the borehole.

18. The method as claimed in claim 17, further comprising the step of uncoupling the pipe from the flexible sleeve after the step of retracting the running device through the borehole.

19. The method as claimed in claim 1, further comprising the step of connecting a pull head with the pipe assembly in order to facilitate the step of connecting the pipe assembly with the running device.

20. The method as claimed in claim 19, further comprising the step of disconnecting the pull head from the pipe assembly after the step of retracting the running device through the borehole.

21. The method as claimed in claim 1, further comprising the step of assembling the pipe assembly.

22. The method as claimed in claim 21 wherein the step of assembling the pipe assembly is comprised of inserting the pipe within a continuous length of the flexible sleeve.

23. The method as claimed in claim 22 wherein the pipe has a pipe length and wherein the flexible sleeve surrounds the pipe along substantially the entire pipe length.

24. A pipe assembly for installation in a borehole, the pipe assembly comprising:
(a) a pipe, wherein the pipe is comprised of a protective coating; and
(b) a flexible sleeve surrounding the pipe, wherein the flexible sleeve is comprised of a continuous length of a flexible sleeve material.

25. The pipe assembly as claimed in claim 24 wherein the flexible sleeve material is seamless.

26. The pipe assembly as claimed in claim 25 wherein the flexible sleeve material is comprised of a woven material.

27. The pipe assembly as claimed in claim 25 wherein the flexible sleeve material is comprised of a woven polyester material.

28. The pipe assembly as claimed in claim 25 wherein the flexible sleeve material is comprised of a twill weave woven polyester material.

29. The pipe assembly as claimed in claim 27 wherein the flexible sleeve material is further comprised of a thermoplastic polyurethane material.

30. The pipe assembly as claimed in claim 24 wherein the flexible sleeve is comprised of a length of a hose.

31. The pipe assembly as claimed in claim 30 wherein the length of the hose is continuous and seamless.

32. The pipe assembly as claimed in claim 31 wherein the hose is comprised of a woven polyester hose material.

33. The pipe assembly as claimed in claim 31 wherein the hose is comprised of a twill weave woven polyester hose material.

34. The pipe assembly as claimed in claim 32 wherein the hose is further comprised of a thermoplastic polyurethane material.

35. The pipe assembly as claimed in claim 24 wherein the flexible sleeve is comprised of a length of an industrial hose.

36. The pipe assembly as claimed in claim 24 wherein the pipe has a pipe length and wherein the flexible sleeve surrounds the pipe along substantially the entire pipe length.

37. The pipe assembly as claimed in claim 24, further comprising a coupler for holding the flexible sleeve on the pipe.

38. The pipe assembly as claimed in claim 37 wherein the coupler is located at an end of the pipe.

39. The pipe assembly as claimed in claim 38 wherein the coupler is comprised of an inner member connected with the pipe and an outer member for connecting with the inner member such that the flexible sleeve is disposed between the inner member and the outer member.

40. The pipe assembly as claimed in claim 39 wherein the coupler is further comprised of a plurality of fasteners for connecting the outer member with the inner member.

41. The pipe assembly as claimed in claim 40 wherein the plurality of fasteners is arranged in a staggered configuration such that none of the fasteners are longitudinally aligned.

42. The pipe assembly as claimed in claim 39 wherein the outer member is comprised of an inner surface for engaging the flexible sleeve and wherein the inner surface is comprised of a gripping surface for resisting movement of the flexible sleeve relative to the inner surface.

43. The pipe assembly as claimed in claim 42 wherein the gripping surface is comprised of rubber.
